(19) United States
(12) Patent Application Publication
(10) Pub. No.: US 2026/0088890 A1
(43) Pub. Date: Mar. 26, 2026

(54) COMMUNICATION RELAY SYSTEM, COMMUNICATION DEVICE AND COMMUNICATION RELAY METHOD

(71) Applicant: MegaChips Corporation, Osaka (JP)

(72) Inventor: Yongwi KIM, Osaka (JP)

(73) Assignee: MegaChips Corporation, Osaka (JP)

(21) Appl. No.: 19/329,624

(22) Filed: Sep. 16, 2025

(30) Foreign Application Priority Data
Sep. 26, 2024 (JP) 2024-167930

(51) Int. Cl. H04B 7/155; H04B 7/0408; H04B 7/0413

(52) U.S. Cl. CPC H04B 7/15507; H04B 7/0408; H04B 7/0413

(57) ABSTRACT

One of a primary device and a secondary device includes a plurality of transmission storages, and a plurality of transmitters respectively corresponding to a plurality of propagation paths. The plurality of transmission storages store and output, in a chronological order and in a complementary manner, frames forming data, and outputs frames to two or more transmitters respectively corresponding to two or more propagation paths during a first transmitting work such that an order of identifiers assigned to the two or more propagation paths used for transmission of frames corresponds to a chronological order of frames to be transmitted. The plurality of transmitters transmit frames output by any of the plurality of transmission storages to another device through a plurality of corresponding propagation paths.

### CROSS-REFERENCE TO RELATED APPLICATION

The present application claims priority of Japanese Patent Application No. 2024-167930, filed Sep. 26, 2024, the entire content of which is incorporated herein by reference in its entirety.

### BACKGROUND

### Technical Field

The present disclosure relates to a communication relay system, a primary device, a secondary device and a communication relay method for relaying communication.

### Description of Related Art

In a data communication system, data is communicated among a plurality of devices through a communication relay system. For example, JP 10-285180 A describes a digital communication system in which a terminal device is connected to an asynchronous transfer mode node of a wide area integrated service digital network through a plurality of stations. Two-way communication is performed among the plurality of stations. In a station that transmits data, cell data being a communication unit and forming data to be transmitted is stored in a cell storage area, and the order information of the cell data is stored in a pointer area. The cell data stored in the cell storage area is transmitted according to the order information stored in the pointer area.

### SUMMARY

With the digital communication system described in JP 10-285180 A, even when being stored in a cell storage area in an arrangement order different from a processing order, cell data can be taken out and processed according to the processing order. However, each time the cell data is stored in the cell storage area, the order information of the cell data needs to be stored in the pointer area. Further, each time the cell data stored in the cell storage area is normally received by a station that receives data, the order information stored in the pointer area needs to be corrected. This increases latency.

An object of the present disclosure is to provide a communication relay system, a primary device, a secondary device and a communication relay method that enable a reduction in latency.

A communication relay system according to the first aspect of the present disclosure includes a plurality of propagation paths to which unique identifiers are assigned, a primary device, and a secondary device capable of communicating with the primary device, wherein one device out of the primary device and the secondary device is capable of performing a first transmitting work of simultaneously transmitting data to another device through two or more propagation paths out of the plurality of propagation path in a single period, and includes a plurality of first transmission storage circuitries configured to store and output, in a chronological order and in a complementary manner, frames forming data, and a plurality of first transmission circuitries configured to be provided to respectively correspond to the plurality of propagation paths, and transmit frames to the another device through the plurality of corresponding propagation paths, with the frames being output by any of the plurality of first transmission storage circuitries, and the plurality of first transmission storage circuitries are configured to output frames to two or more first transmission circuitries respectively corresponding to two or more propagation paths during the first transmitting work such that an order of identifiers assigned to the two or more propagation paths used for transmission of frames corresponds to a chronological order of frames to be transmitted.

A primary device according to the second aspect of the present disclosure is provided in a communication relay system, with the communication relay system including a plurality of propagation paths to which unique identifiers are assigned and a secondary device, wherein the primary device is capable of communicating with the secondary device, is capable of performing a first transmitting work of simultaneously transmitting data to the secondary device through two or more propagation paths out of the plurality of propagation paths in a single period, and includes a plurality of transmission storage circuitries configured to store and output, in a chronological order and in a complementary manner, frames forming data, and a plurality of transmission circuitries configured to be provided to respectively correspond to the plurality of propagation paths, and transmit frames output by any of the plurality of transmission storage circuitries to the secondary device through the plurality of corresponding propagation paths, and the plurality of transmission storage circuitries are configured to output frames to two or more transmission circuitries respectively corresponding to two or more propagation paths during the first transmitting work such that an order of identifiers assigned to the two or more propagation paths used for transmission of frames corresponds to a chronological order of frames to be transmitted.

A secondary device according to the third aspect of the present disclosure is provided in a communication system, with the communication system including a plurality of propagation paths to which unique identifiers are assigned and a primary device, wherein the secondary device is capable of communicating with the primary device, is capable of performing a first transmitting work of simultaneously transmitting data to the primary device through two or more propagation paths out of the plurality of propagation paths in a single period, and includes a plurality of transmission storage circuitries configured to store and output, in a chronological order and in a complementary manner, frames forming data, and a plurality of transmission circuitries configured to be provided to respectively correspond to the plurality of propagation paths, and transmit frames output by any of the plurality of transmission storage circuitries to the primary device through the plurality of corresponding propagation paths, and the plurality of transmission storage circuitries are configured to output frames to two or more transmission circuitries respectively corresponding to two or more propagation paths such that an order of identifiers assigned to the two or more propagation paths used for transmission of frames corresponds to a chronological order of frames to be transmitted.

A communication relay method according to the fourth aspect of the present disclosure with which a plurality of propagation paths to which unique identifiers are assigned, a primary device and a secondary device are used, wherein the secondary device is capable of communicating with the primary device, one device out of the primary device and the secondary device is capable of performing a first transmitting work of simultaneously transmitting data to another device through two or more propagation paths out of the plurality of propagation paths in a single period using a plurality of transmission storage circuitries and a plurality of transmission circuitries, with the plurality of transmission circuitries being provided to respectively correspond to the plurality of propagation paths, and the communication relay method includes storing frames in a chronological order and in a complementary manner using the plurality of transmission storage circuitries, with the frames forming data, outputting, during the first transmitting work, frames stored by the plurality of transmission storage circuitries to two or more transmission circuitries respectively corresponding to two or more propagation paths such that an order of identifiers assigned to the two or more propagation paths used for transmission of frames corresponds to a chronological order of frames to be transmitted, and transmitting frames output by the plurality of transmission storage circuitries to the another device through the plurality of respectively corresponding propagation paths using the plurality of transmission circuitries.

With the present disclosure, latency can be reduced.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing the configuration of a communication relay system according to one embodiment of the present disclosure;

FIG. 2 is a diagram showing one example of communication periods allocated to propagation paths;

FIG. 3 is a diagram showing the configuration of each secondary device;

FIG. 4 is a schematic diagram for explaining the work of transmission memories;

FIG. 5 is a schematic diagram for explaining the work of reception memories;

FIG. 6 is a diagram showing the configuration of a primary device;

FIG. 7 is a schematic diagram for explaining the work of transmission memories;

FIG. 8 is a schematic diagram for explaining the work of reception memories;

FIG. 9 is a block diagram showing the functional configuration of the primary device;

FIG. 10 is a diagram showing one example of the length of a frame and the number of frames monitored by a monitor;

FIG. 11 is a diagram showing an example of adjustment of the length of a temporary frame;

FIG. 12 is a diagram showing one example of division and distribution of temporal frames;

FIG. 13 is a flowchart showing one example of a table generation process;

FIG. 14 is a diagram showing the configurations of a transmitter and a receiver;

FIG. 15 is a diagram showing a waveform of data transmitted by each wire;

FIG. 16 is a diagram showing the structure of a frame;

FIG. 17 is a schematic diagram for explaining the work of the communication relay system in a case in which K is four;

FIG. 18 is a schematic diagram for explaining the work of the communication relay system in a case in which K is four;

FIG. 19 is a schematic diagram for explaining the work of the communication relay system in a case in which K is four;

FIG. 20 is a schematic diagram for explaining the work of the communication relay system in a case in which K is four;

FIG. 21 is a schematic diagram for explaining the work of the communication relay system in a case in which K is four; and

FIG. 22 is a schematic diagram for explaining the work of the communication relay system in a case in which K is four.

### DETAILED DESCRIPTION

### 1. Configuration of Communication Relay System

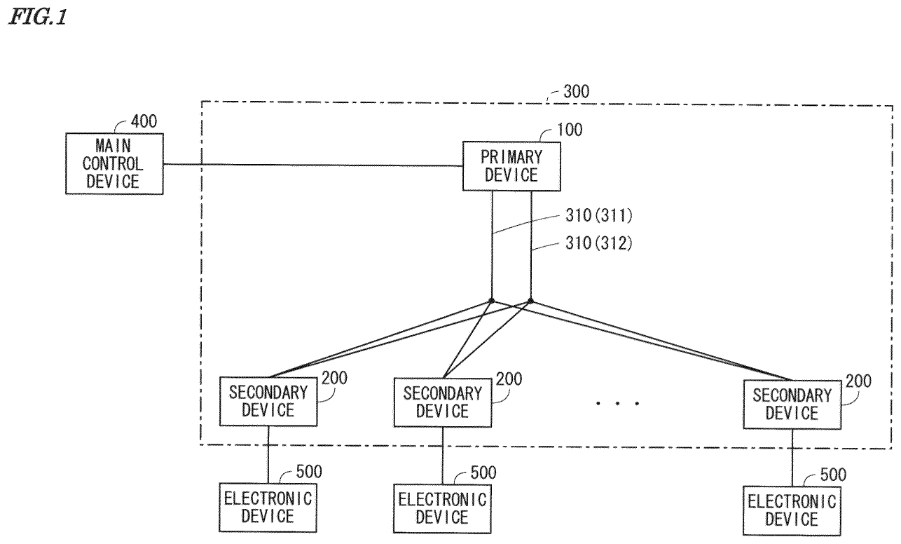

A communication relay system, a primary device, a secondary device and a communication relay method according to embodiments of the present disclosure will be described below in detail with reference to the drawings. FIG. 1 is a diagram showing the configuration of a communication relay system according to one embodiment of the present disclosure. As shown in FIG. 1, the communication relay system 300 includes a primary device 100, a plurality of secondary devices 200 and a plurality of propagation paths 310. A unique identifier (a number in the present example) is assigned to each propagation path 310. In the example of FIG. 1, the communication relay system 300 includes two propagation paths 311, 312 as the plurality of propagation paths 310. The number “1” is assigned to the propagation path 311, and the number “2” is assigned to the propagation path 312.

The respective secondary devices 200 are connected in parallel to the primary device 100 by the plurality of propagation paths 310. That is, in the present example, the primary device 100 and each secondary device 200 are connected to each other by the propagation path 311, and are connected to each other by the propagation path 312. Further, the primary device 100 and each secondary device 200 are connected to each other by a signal line (not shown). A control signal is provided through the signal line from the primary device 100 to each secondary device 200, so that the work of each secondary device 200 is controlled.

The primary device 100 is connected to a main control device 400 provided outside of the communication relay system 300. The plurality of secondary devices 200 are respectively connected to a plurality of electronic devices 500 provided outside of the communication relay system 300. The main control device 400 controls the work of each electronic device 500, and generates or processes data. Each electronic device 500 generates or processes data. The main control device 400 and each electronic device 500 conform to the Ethernet standard, for example. Therefore, data generated or processed in the main control device 400 and each electronic device 500 is formed of one or more frames, and each frame has a predetermined structure such as the Ethernet frame.

The primary device 100 acquires data from the connected main control device 400, and provides the data to any of the secondary devices 200 through the propagation path 311 or the propagation path 312. Further, the primary device 100 acquires data from any of the secondary devices 200 through the propagation path 311 or the propagation path 312, and provides data to any of the secondary devices 200 through the propagation path 311 or the propagation path 312.

Each secondary device 200 acquires data from the connected electronic device 500 and provides the data to the primary device 100 through the propagation path 311 or the propagation path 312. Further, each secondary device 200 acquires data from the primary device 100 through the propagation path 311 or the propagation path 312, and provides the data to the connected electronic device 500. Thus, in the communication relay system 300, communication is relayed between the main control device 400 and the plurality of electronic devices 500.

The communication relay system 300 is mounted on an FA (Factory Automation) device, for example. In this case, the main control device 400 includes an MCU (Micro Controller Unit), and an electronic device 500 includes a camera, a sensor, a computer or the like. The camera includes an ultra-high definition camera such as a 4K camera or an 8K camera. The sensor includes various sensors such as a speed sensor, an acceleration sensor and an angle sensor. Therefore, the size of data to be generated or processed greatly varies for each electronic device 500. In particular, in a case in which being image data generated by an ultra-high definition camera, data has an extremely large size. As such, during communication of data having a large size, the two propagation paths 311, 312 are simultaneously used during communication.

Specifically, in the communication relay system 300, a table in which periods to be used for communication with each secondary device 200 are allocated is generated for each of the propagation paths 311, 312. While frames having a predetermined structure such as an Ethernet frame are allocated to any period in the generated table, the primary device 100 and each secondary device 200 communicate with each other periodically and repeatedly through the propagation paths 311, 312. Therefore, the periods during which the primary device 100 communicate with each secondary device 200 are allocated to each of the propagation paths 311, 312. The step of generating a table will be described below.

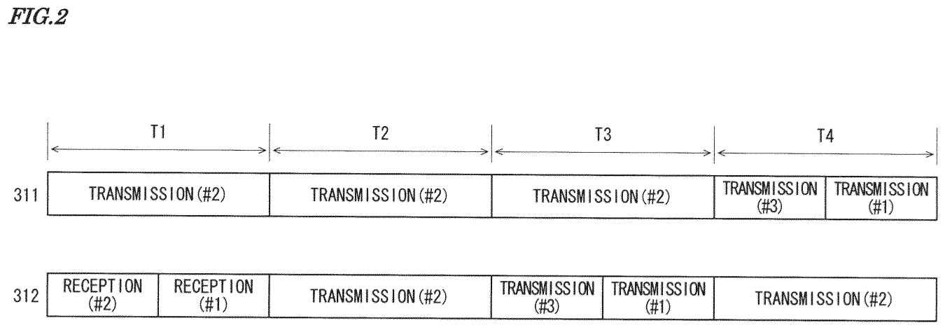

FIG. 2 is a diagram showing one example of communication periods allocated to the propagation paths 311, 312. In the present example, communication from any secondary device 200 to the primary device 100 is described as “TRANSMISSION,” and communication received by any secondary device 200 from the primary device 100 is described as “RECEPTION.” Further, a unique number assigned to a secondary device 200 that performs communication is indicated in parentheses after “TRANSMISSION” or “RECEPTION.”

As shown in FIG. 2, in a period T1, transmission by a second secondary device 200 is allocated to the propagation path 311, and reception by a second secondary device 200 and reception by a first secondary device 200 are sequentially allocated to the propagation path 312. In a period T2 following the period T1, transmission by the second secondary device 200 is allocated to the propagation path 311, and transmission by the second secondary device 200 is allocated to the propagation path 312.

In a period T3 following the period T2, transmission by the second secondary device 200 is allocated to the propagation path 311, and transmission by a third secondary device 200 and transmission by the first secondary device 200 are sequentially allocated to the propagation path 312. In a period T4 following the period T3, transmission by the third secondary device 200 and transmission by the first secondary device 200 are sequentially allocated to the propagation path 311, and transmission by the second secondary device 200 is allocated to the propagation path 312.

In regard to this allocation, in the period T2, the propagation paths 311, 312 are occupied by the transmission by the second secondary device 200. Therefore, even in a case in which data is image data or the like having a large size, the second secondary device 200 can efficiently transmit the data to the primary device 100 by simultaneously using the propagation paths 311, 312 in the period T2. Also during reception, in a case in which data has a large size, the propagation paths 311, 312 are occupied in the same manner as during transmission.

### 2. Secondary Device

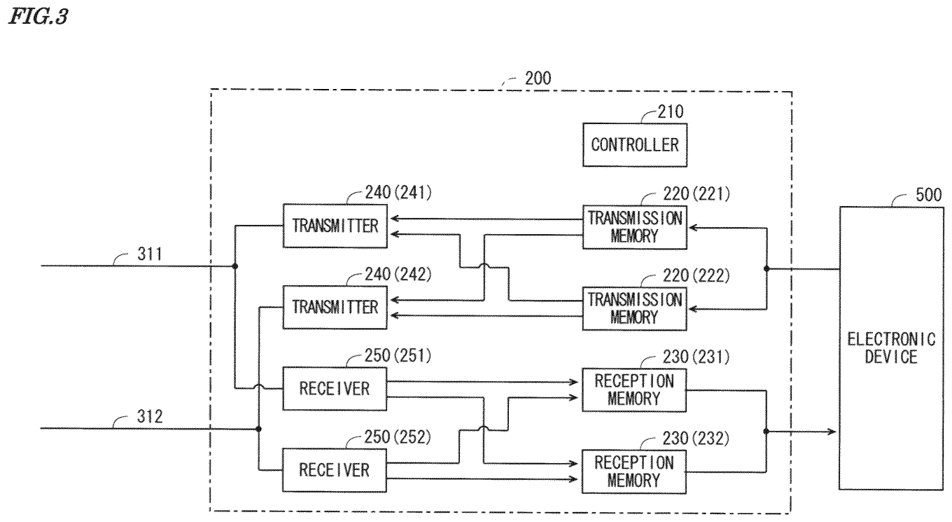

FIG. 3 is a diagram showing the configuration of each secondary device 200. As shown in FIG. 3, the secondary device 200 includes a controller 210, a plurality of transmission memories 220, a plurality of reception memories 230, a plurality of transmitters 240 and a plurality of receivers 250. The controller 210 includes a processor such as a CPU (Central Processing Unit). The controller 210 controls the work of the plurality of transmission memories 220 and the plurality of reception memories 230 in accordance with a control signal provided by the primary device 100.

The number of transmission memories 220, the number of reception memories 230, the number of transmitters 240 and the number of receivers 250 correspond to the number of propagation paths 310. As described above, in the present example, the number of propagation paths 310 is two. Therefore, in the present example, the secondary device 200 includes two transmission memories 221, 222 as the plurality of transmission memories 220, and two reception memories 231, 232 as the plurality of reception memories 230. Further, the secondary device 200 includes two transmitters 241, 242 as the plurality of transmitters 240, and two receivers 251, 252 as the plurality of receivers 250.

Each of the transmission memories 221, 222 and each of the reception memories 231, 232 are volatile memories of an FIFO (First In First Out) system, and temporarily store frames of data. Each of the transmission memories 221, 222 and each of the reception memories 231, 232 are connected to an electronic device 500. Further, each of the transmission memories 221, 222 is connected to the transmitter 241 and the transmitter 242. Each of the reception memories 231, 232 is connected to the receiver 251 and the receiver 252.

Each of the transmitters 241, 242 and each of the receivers 251, 252 are formed of electronic circuits, for example. The transmitter 241 is connected to the propagation path 311, and transmits frames output by the transmission memories 221, 222 to the primary device 100 through the propagation path 311. The transmitter 242 is connected to the propagation path 312, and transmits frames output by the transmission memories 221, 222 to the primary device 100 through the propagation path 312. The receiver 251 is connected to the propagation path 311, and receives frames transmitted by the primary device 100 through the propagation path 311. The receiver 252 is connected to the propagation path 312, and receives frames transmitted by the primary device 100 through the propagation path 312.

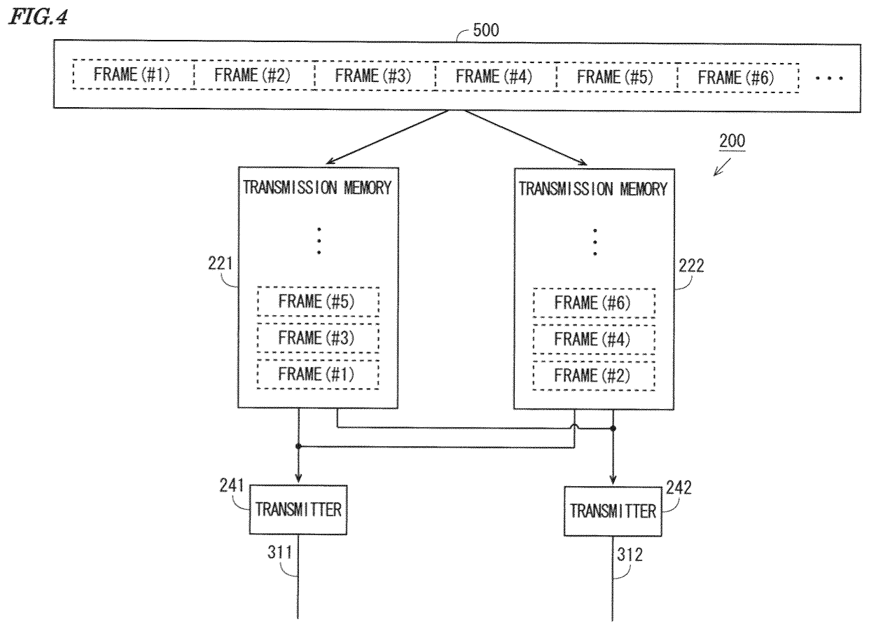

FIG. 4 is a schematic diagram for explaining the work of the transmission memories 221, 222. As shown in FIG. 4, the electronic device 500 provides data formed of a plurality of frames to the secondary device 200. In the present example, in order to facilitate understanding, a number indicating a chronological order of generated frames is indicated in parentheses after “FRAME.” However, data does not include information representing the order of frames.

The transmission memories 221, 222 store frames of data provided by the electronic device 500 in a complementary manner. In the example of FIG. 4, a first frame, a third frame and a fifth frame are stored in the transmission memory 221 in this order. Further, a second frame, a fourth frame and a sixth frame are stored in the transmission memory 222 in this order. Thereafter, the transmission memories 221, 222 output the stored frames to the transmitters 241, 242 in periods allocated to the propagation paths 311, 312.

Here, in a period during which either one of the propagation paths 311, 312 is occupied by transmission but not both, the transmission memories 221, 222 output the stored frames to the transmitter 241 or the transmitter 242 in a chronological order and in a complementary manner. Specifically, the output of the first frame by the transmission memory 221, the output of the second frame by the transmission memory 222, the output of the third frame by the transmission memory 221, the output of the fourth frame by the transmission memory 222 and so on are sequentially executed. The output destination of frames is the transmitter 241 in the period of transmission through the propagation path 311, and is the transmitter 242 in the period of transmission through the propagation path 312.

On the other hand, in a period during which both of the propagation paths 311, 312 are occupied by transmission, the transmission memories 221, 222 output the stored frames to the transmitter 241 and the transmitter 242 in a chronological order and simultaneously. In this case, the output destinations of a preceding frame and a subsequent frame in a chronological order are determined in advance. In the present example, the preceding frame is transmitted through the propagation path 311 to which the number “1” is assigned, and the subsequent frame is transmitted through the propagation path 312 to which the number “2” is assigned. Therefore, the output destination of the preceding frame is the transmitter 241, and the output destination of the subsequent frame is the transmitter 242.

For example, in a case in which the output of the first frame by the transmission memory 221 and the output of the second frame by the transmission memory 222 are simultaneously executed, the first frame, which is the preceding frame, is output to the transmitter 241, and the second frame, which is the subsequent frame, is output to the transmitter 242. On the other hand, in a case in which the output of the second frame by the transmission memory 222 and the output of the third frame by the transmission memory 221 are simultaneously executed, the second frame, which is the preceding frame, is output to the transmitter 241, and the third frame, which is the subsequent frame, is output to the transmitter 242.

Further, as described below, data is transmitted by the primary device 100 through the propagation paths 311, 312. Frames of data transmitted by the primary device 100 includes frames corresponding to the plurality of secondary devices 200. In this case, the receivers 251,252 of each secondary device 200 receive frames of data corresponding to the secondary device 200.

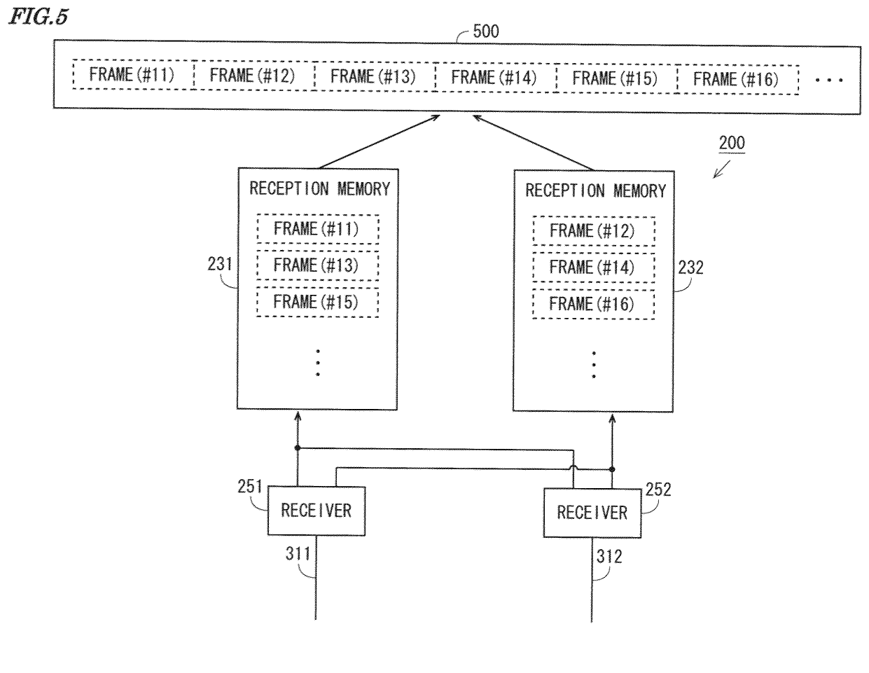

FIG. 5 is a schematic diagram for explaining the work of the reception memories 231, 232. As shown in FIG. 5, the reception memories 231, 232 store frames received by the receivers 251, 252 in a complementary manner. In the example of FIG. 5, an eleventh frame, a thirteenth frame and a fifteenth frame are stored in the reception memory 231 in this order. Further, a twelfth frame, a fourteenth frame and a sixteenth frame are stored in the reception memory 232 in this order.

Here, in a period during which either one of the propagation paths 311, 312 is occupied by reception but not both, the reception memories 231, 232 store, in a chronological order and in a complementary manner, the frames received by the receiver 251 or the receiver 252. Specifically, the storage of the eleventh frame by the reception memory 231, the storage of the twelfth frame by the reception memory 232, the storage of the thirteenth frame by the reception memory 231, the storage of the fourteenth frame by the reception memory 232 and so on are sequentially executed.

On the other hand, in a period during which the propagation paths 311, 312 are occupied by reception, the reception memories 231, 232, in a chronological order and simultaneously, acquire and store the frames received by the receivers 251, 252. In this case, as described above, a preceding frame is transmitted through the propagation path 311 and a subsequent frame is transmitted through the propagation path 312. Therefore, the preceding frame is received by the receiver 251, and the subsequent frame is received by the receiver 252. Therefore, in the present example, a reception memory that is to store a subsequent frame out of the reception memories 231, 232 stores the frame received by the receiver 251, and the other reception memory out of the reception memories 231, 232 stores the frame received by the receiver 252.

Thereafter, the reception memories 231, 232 output the stored frames to the electronic device 500 in a chronological order and in a complementary manner. Each secondary device 200 works as described above, and the primary device 100 performs a transmitting-receiving work corresponding to the work of each secondary device 200. The transmitting-receiving work of the primary device 100 will be described below. Thus, in each period shown as an example in FIG. 2, frames are communicated between the plurality of secondary devices 200 and the primary device 100 through the propagation paths 311, 312.

### 3. Primary Device

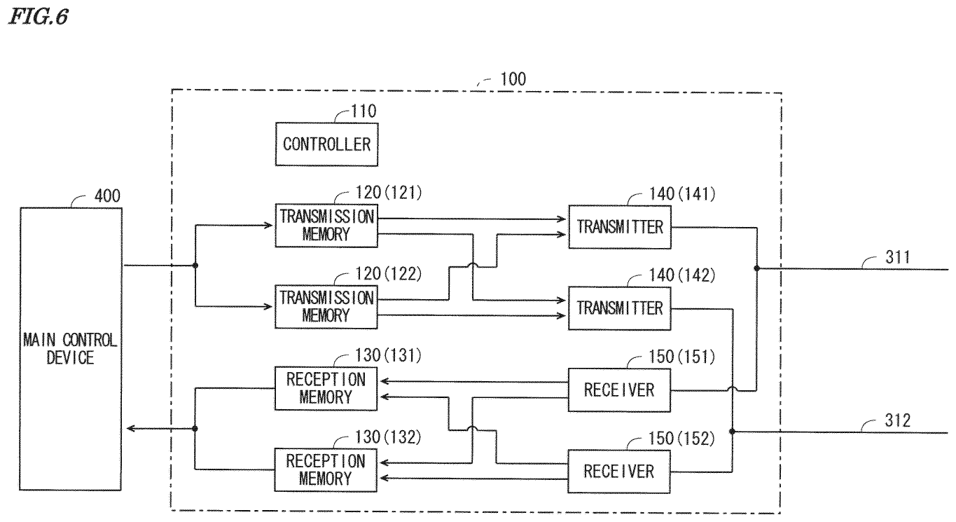

FIG. 6 is a diagram showing the configuration of the primary device 100. FIG. 6 mainly shows the hardware configuration of the primary device 100. As shown in FIG. 6, the primary device 100 includes a controller 110, a plurality of transmission memories 120, a plurality of reception memories 130, a plurality of transmitters 140 and a plurality of receivers 150. The controller 110 includes a processor such as a CPU, and a memory, and controls the work of the plurality of transmission memories 120 and the plurality of reception memories 130. Further, the controller 110 also provides a control signal for controlling the transmission memories 220 and the reception memories 230 to the controller 210 of each secondary device 200 in FIG. 3.

The configuration of the primary device 100 is similar to the configuration of the secondary device 200. Therefore, the primary device 100 includes two transmission memories 121, 122 as the plurality of transmission memories 120 and two reception memories 131, 132 as the plurality of reception memories 130. Further, the primary device 100 includes two transmitters 141, 142 as the plurality of transmitters 140 and two receivers 151, 152 as the plurality of receivers 150.

Each of the transmission memories 121, 122 and each of the reception memories 131, 132 are volatile memories of an FIFO system, and temporarily store frames of data. Each of the transmission memories 121, 122 and each of the reception memories 131, 132 are connected to the main control device 400. Further, each of the transmission memories 121, 122 is connected to the transmitters 141, 142. Each of the reception memories 131, 132 is connected to the receivers 151, 152.

Each of the transmitters 141, 142 and each of the receivers 151, 152 are formed of electronic circuits, for example. The transmitter 141 is connected to the propagation path 311, and transmits frames output by the transmission memories 121, 122 to the secondary device 200 through the propagation path 311. The transmitter 142 is connected to the propagation path 312, and transmits frames output by the transmission memories 121, 122 to the secondary device 200 through the propagation path 312. The receiver 151 is connected to the propagation path 311, and receives frames transmitted by each secondary device 200 through the propagation path 311. The receiver 152 is connected to the propagation path 312, and receives frames transmitted by each secondary device 200 through the propagation path 312.

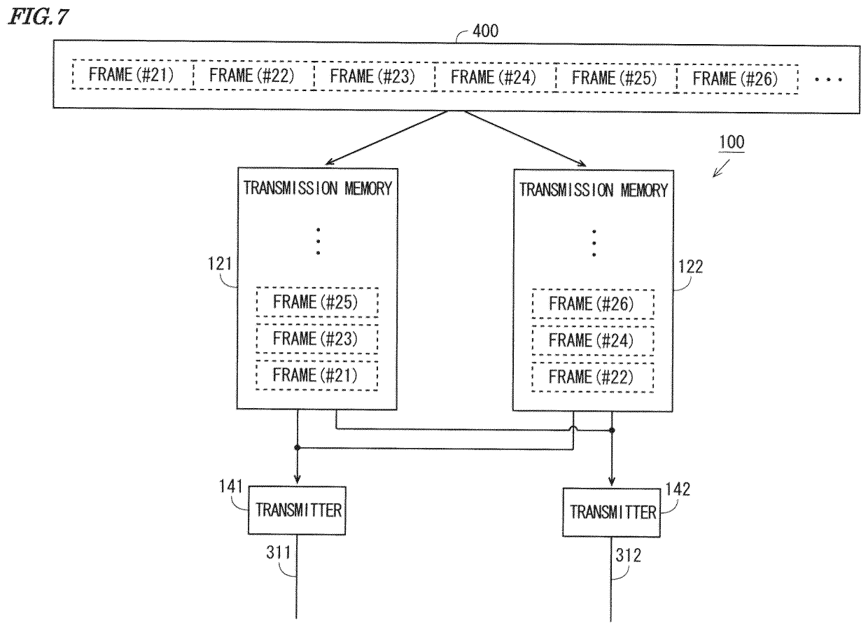

FIG. 7 is a schematic diagram for explaining the work of the transmission memories 121, 122. As shown in FIG. 7, the main control device 400 provides data formed of a plurality of frames to the primary device 100. The plurality of frames of data provided from the main control device 400 to the primary device 100 include frames corresponding to the plurality of secondary devices 200.

The transmission memories 121, 122 store frames of data provided by the main control device 400 in a complementary manner. In the example of FIG. 7, a twenty-first frame, a twenty-third frame and a twenty-fifth frame are stored in the transmission memory 121 in this order. Further, a twenty-second frame, a twenty-fourth frame and a twenty-sixth frame are stored in the transmission memory 122 in this order. Thereafter, the transmission memories 121, 122 output the stored frames to the transmitters 141, 142 in a period allocated to the propagation paths 311, 312.

Here, in a period during which either one of the propagation paths 311, 312 is occupied by transmission but not both, the transmission memories 121, 122 output the stored frames to the transmitter 141 or the transmitter 142 in a chronological order and in a complementary manner. Specifically, the output of the twenty-first frame by the transmission memory 121, the output of the twenty-second frame by the transmission memory 122, the output of the twenty-third frame by the transmission memory 121, the output of the twenty-fourth frame by the transmission memory 122 and so on are sequentially executed. The output destination of frames is the transmitter 141 in the period of transmission through the propagation path 311, and is the transmitter 142 in the period of transmission through the propagation path 312.

On the other hand, in a period during which both of the propagation paths 311, 312 are occupied by transmission, the transmission memories 121, 122 output the stored frames to the transmitter 141 and the transmitter 142 in a chronological order and simultaneously. In the present example, the output destination of a preceding frame is the transmitter 141, and the output destination of a subsequent frame is the transmitter 142. In this case, the preceding frame is transmitted through the propagation path 311, and the subsequent frame is transmitted through the propagation path 312.

For example, in a case in which the output of the twenty-first frame by the transmission memory 121 and the output of the twenty-second frame by the transmission memory 122 are simultaneously executed, the twenty-first frame, which is the preceding frame, is output to the transmitter 141, and the twenty-second frame, which is the subsequent frame, is output to the transmitter 142. On the other hand, in a case in which the output of the twenty-second frame by the transmission memory 122 and the output of the twenty-third frame by the transmission memory 121 are simultaneously executed, the twenty-second frame, which is the preceding frame, is output to the transmitter 141, and the twenty-third frame, which is the subsequent frame, is output to the transmitter 142.

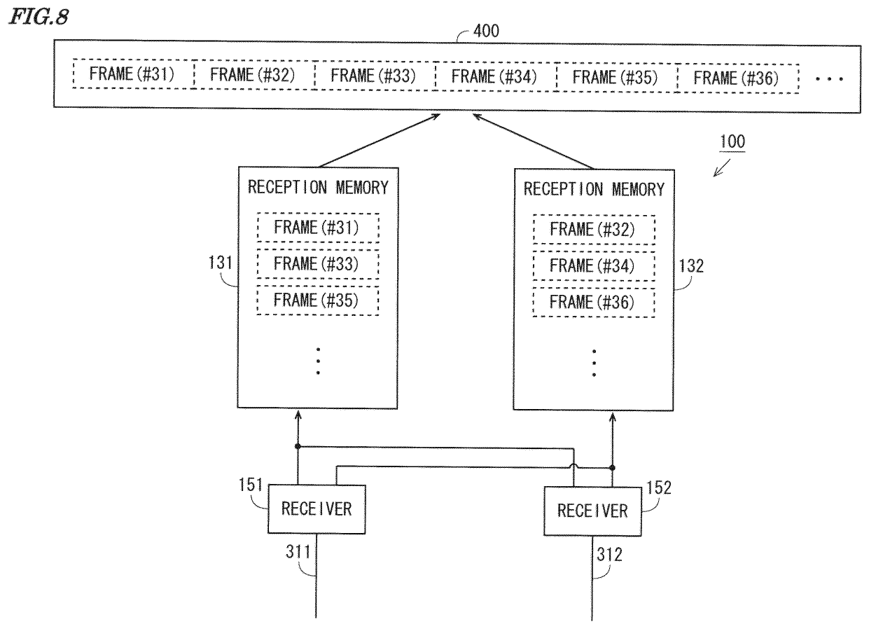

FIG. 8 is a schematic diagram for explaining the work of the reception memories 131, 132. As described with reference to FIG. 4, when data is transmitted by each secondary device 200 to the primary device 100, the receivers 151, 152 receive frames of the data. In this case, as shown in FIG. 8, the reception memories 131, 132 store the frames received by the receivers 151, 152 in a complementary manner. In the example of FIG. 8, a thirty-first frame, a thirty-third frame and a thirty-fifth frame are stored in the reception memory 131 in this order. Further, a thirty-second frame, a thirty-fourth frame and a thirty-sixth frame are stored in the reception memory 132 in this order.

Here, in a period during which either one of the propagation paths 311, 312 is occupied by reception but not both, the reception memories 131, 132 store, in a chronological order and in a complementary manner, the frames received by the receivers 151, 152. Specifically, the storage of the thirty-first frame by the reception memory 131, the storage of the thirty-second frame by the reception memory 132, the storage of the thirty-third frame by the reception memory 131, the storage of the thirty-fourth frame by the reception memory 132 and so on are sequentially executed.

On the other hand, in a period during which the propagation paths 311, 312 are occupied by reception, the reception memories 131, 132 store, in a chronological order and simultaneously, the frames received by the receivers 151, 152. In this case, as described above, a preceding frame is transmitted through the propagation path 311, and a subsequent frame is transmitted through the propagation path 312. Therefore, the preceding frame is received by the receiver 151, and the subsequent frame is received by the receiver 152. Therefore, in the present example, a reception memory that is to store a subsequent frame out of the reception memories 131, 132 stores the frame received by the receiver 151, and the other reception memory out of the reception memories 131, 132 stores the frame received by the receiver 152.

Thereafter, the reception memories 131, 132 output the stored frames to the main control device 400 in a chronological order and in a complementary manner. The primary device 100 works as described above, and each secondary device 200 performs a transmitting-receiving work corresponding to the work of the primary device 100. Thus, in each period shown as an example in FIG. 2, frames are communicated between the plurality of secondary devices 200 and the primary device 100 through the propagation paths 311, 312.

### 4. Generation of Table

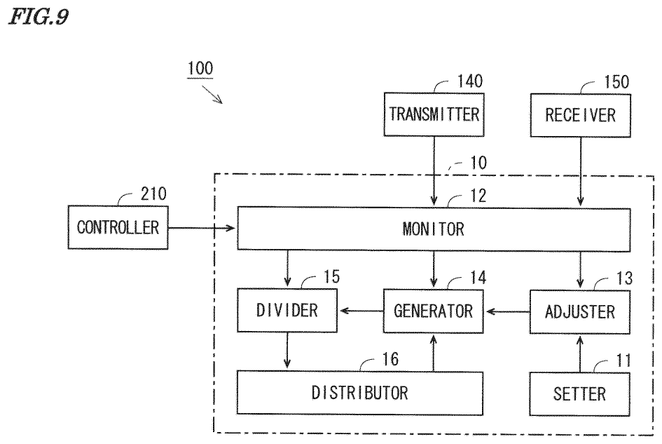

As described above, the primary device 100 generates a table for each of the propagation paths 311, 312. FIG. 9 is a block diagram showing the functional configuration of the primary device 100. As shown in FIG. 9, the primary device 100 includes, as functions 10, a setter 11, a monitor 12, an adjuster 13, a generator 14, a divider 15 and a distributor 16. In the present example, the functions 10 of the primary device 100 are implemented by execution by the processor of the controller 110 of a table generation program stored in a memory.

The setter 11 sets, in a table, the length of a temporary frame indicating a period to be allocated to transmission or reception of each secondary device 200, and stores the set length of the temporary frame in a memory as an initial setting. The length of a temporary frame may be set equally with respect to all of the secondary devices 200. In this case, the length of a temporary frame is set sufficiently large. On the other hand, in regard to a secondary device 200 connected to an electronic device 500 with which communication may not be established due to a handshake failure or the like, the length of a temporary frame for transmission may be set larger than the length of another temporary frame. The setter 11 may set the length of a temporary frame by reading the past initial setting.

Alternatively, in a case in which the primary device 100 is connected to a computer including a display device, an operation device and the like, the setter 11 may accept an operation of inputting a length of a temporary frame from a user as an initial setting operation. The user can check a communication amount of each secondary device 200 by viewing a GUI (Graphical User Interface) displayed on the display device, and can input an appropriate length of a temporary frame corresponding to the communication amount to the setter 11 by operating the operation device. In this case, the setter 11 sets the length of the accepted temporary frame.

The monitor 12 monitors the length of a frame and the number of frames received by each secondary device 200 per unit time by acquiring data transmitted by the transmitter 140, with the data being originally transmitted from the main control device 400. Further, the monitor 12 monitors the length of a frame and the number of frames transmitted from each secondary device 200 per unit time by acquiring data received by the receiver 150, with the data being originally transmitted from each secondary device 200. The monitor 12 may monitor the length of a frame and the number of frames by individually communicating with each secondary device 200. Alternatively, the monitor 12 may monitor the length of a frame and the number of frames by individually communicating with the main control device 400 and each electronic device 500.

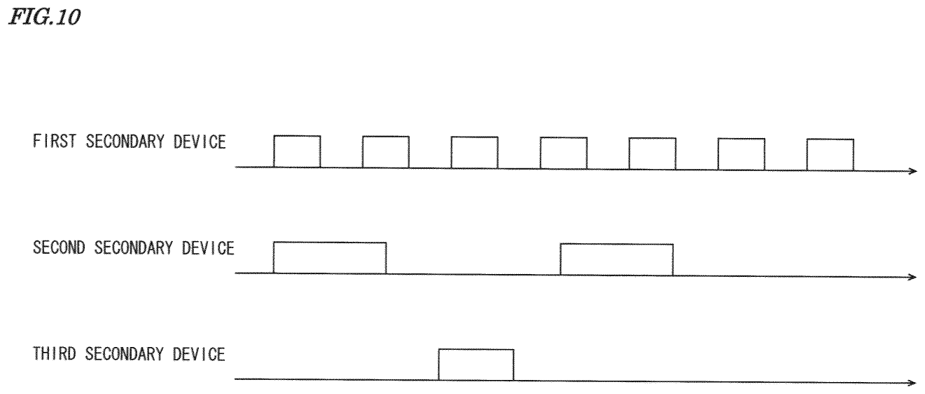

FIG. 10 is a diagram showing one example of the length of a frame and the number of frames monitored by the monitor 12. In the example of FIG. 10, the length of a frame transmitted by the second secondary device 200 is the largest, and the length of a frame transmitted by the first secondary device 200 is the smallest. However, the number of frames transmitted by the first secondary device 200 in a unit time is the largest. Since a communication amount of frames is provided by a product of the length of a frame and the number of frames, a communication amount in the first secondary device 200 is the largest.

The adjuster 13 adjusts the length of a temporary frame set by the setter 11 based on the length of a frame and the number of frames monitored by the monitor 12. For example, the length of a temporary frame is Ne, and the length of the largest frame is Nmax. Further, the length of a frame having the largest communication amount (hereinafter referred to as a maximum communication frame) is N, and the number of maximum communication frames is n. In this case, the number of maximum communication frames and the length of a temporary frame are adjusted such that the following formulas (1) and (2) hold.

$$Nmax \leq Ne \qquad ( 1 )$$

$$n \times N < Ne < n \times N + α \qquad ( 2 )$$

Therefore, with a combination of the formulas (1) and (2), the number of maximum communication frames and the length of a temporary frame are adjusted such that the following formula (3) holds. For example, the number of maximum communication frames and the length of a temporary frame may be adjusted to be the smallest values within a range in which the formula (3) holds. Here, a is a margin of a temporary frame provided to prevent an occurrence of overflow, and is set to a value smaller than 25% (0.25×N) of the length of the maximum communication frame in the present example.

$$Nmax \leq Ne < n \times N + α \qquad ( 3 )$$

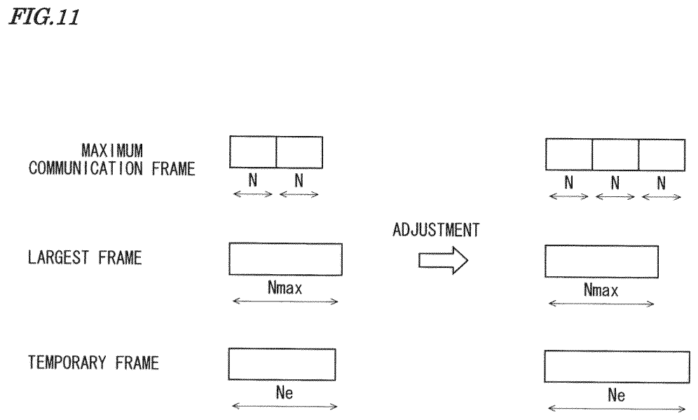

FIG. 11 is a diagram showing an example of adjustment of the length of a temporary frame. As shown in the left field of FIG. 11, before adjustment, in a case in which the number of maximum communication frames is two, although an inequality on the right side of the formula (3) holds, a non-strict inequality on the left side of the formula (3) does not hold. Therefore, as shown on the right field of FIG. 11, the length of a temporary frame is adjusted to be increased. With this adjustment, the non-strict inequality on the left side of the formula (3) holds. Further, even in a case in which the number of maximum communication frames is adjusted to three, the inequality on the right side of the formula (3) holds.

The generator 14 generates a table for each of the propagation paths 311, 312 by determining, for each of the propagation paths 311, 312, a temporary frame to be allocated to a frame of each secondary device 200. Frames of each secondary device 200 include a transmission frame and a reception frame. Specifically, the generator 14 first determines the length of a table based on the length of a temporary frame adjusted by the adjuster 13. In the present example, the length of the table is determined to be eight times of the length of the temporary frame. That is, the table includes eight temporary frames.

Next, the generator 14 determines, from among a plurality of temporary frames included in the table of each of the propagation paths 311, 312, a temporary frame to be allocated to a frame of each secondary device 200. In the present example, a temporary frame to be allocated to a frame of the secondary device 200 is determined in a descending order of a communication amount. In the above-mentioned example, a communication amount during transmission of the first secondary device 200 is the largest. In this case, when a period of time in the table is S [seconds], and a communication speed of the first secondary device 200 is X [bytes/second], a length Y [bytes] required for allocation to the transmission of the first secondary device 200 in the table is provided by X×S.

Further, when the length of a maximum communication frame is N1 [bytes], the length y [bytes] of a frame that can be transmitted by the first secondary device 200 per temporary frame is provided by N1×k. Here, k is the maximum value for the number n of maximum communication frames, with the number satisfying n<Ne/N1, and is three in the example of FIG. 11. In this case, the number M of temporary frames to be allocated to transmission frames of the first secondary device 200 is provided by an integer satisfying the following formula (4).

$$M > Y / y \qquad ( 4 )$$

Here, in regard to a secondary device 200 connected to an ultra-high definition camera or the like, since a communication amount is large, a plurality of frames each of which has a relatively large length are highly likely to be transmitted in a unit time. Therefore, a temporary frame located in the same period (the period T2 in the example of FIG. 2) in the table for each of the propagation path 311 and the propagation path 312 is allocated to a frame of such a secondary device 200. Temporary frames to be allocated to frames of the secondary devices 200 having the second largest communication amount and smaller communication amounts are also sequentially determined in the same manner.

While a temporary frame of a table to be allocated to a frame of each secondary device 200 is determined in a descending order of a communication amount in the above-mentioned example, the embodiment is not limited to this. In a case in which the priority order for each secondary device 200 is known, a temporary frame of a table to be allocated to a frame of each secondary device 200 may be determined in the priority order. For example, in regard to a secondary device 200 connected to an ultra-high quality camera or the like, since a communication amount is large, a temporary frame may be preferentially allocated to a frame of the secondary device 200.

In a case in which a plurality of frames are allocated to one temporary frame in regard to any of the secondary devices 200, the divider 15 determines whether the temporary frame is to be divided. In a case in which m temporary frames each of which can be divided into m (m is an integer equal to or larger than two) temporary frames are present, and the m temporary frames are allocated to frames of different secondary devices 200, it is determined that a temporary frame is to be divided. In this case, the divider 15 divides each of the m temporary frames in a table generated by the generator 14 into m temporary frames. The distributor 16 equally distributes and rearranges the temporary frames into which each temporary frame has been divided by the divider 15.

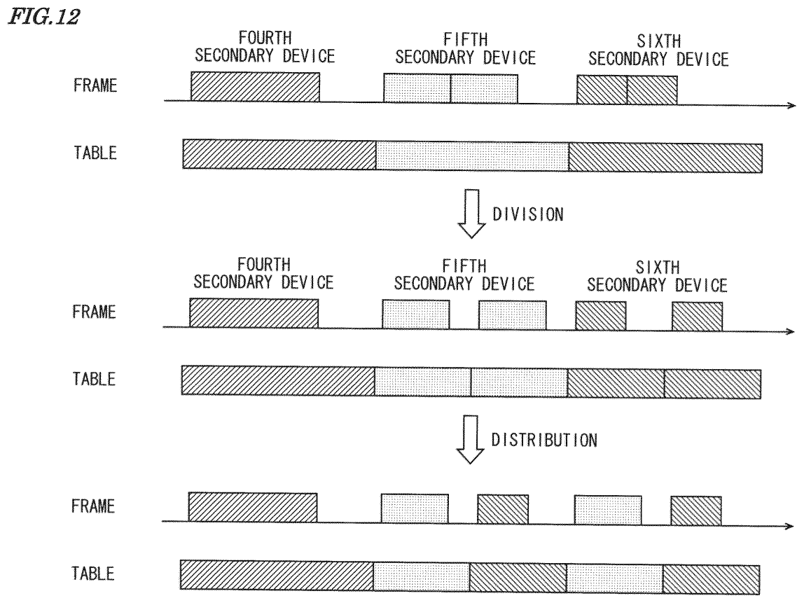

FIG. 12 is a diagram showing one example of division and distribution of temporal frames. In the example of FIG. 12, as shown in the upper field, frames of the fourth to sixth secondary devices 200 are respectively allocated to first to third temporary frames of a table. Specifically, two transmission frames of the fifth secondary device 200 are allocated to the second temporary frame, and two transmission frames of the sixth secondary device 200 are allocated to the third temporary frame. In this case, the second temporary frame can be divided into two second temporary frames such that one transmission frame of the fifth secondary device 200 is allocated to each of the second temporary frames. Similarly, the third temporary frame can be divided into two third temporary frames such that one transmission frame of the sixth secondary device 200 is allocated to each of the third temporary frames.

In this manner, two temporary frames each of which can be divided into two are present, and the two temporary frames are allocated to the transmission frames of the different secondary devices 200. Therefore, it is determined that each of the second and third temporary frames is to be divided into two temporary frames. Thus, as shown in the middle field of FIG. 12, each of the second and third temporary frames in the table is divided into two temporary frames by the divider 15.

Therefore, in the lower field of FIG. 12, in the table, temporary frames obtained when each of the second temporary frame and the third temporary frame is divided into two temporary frames are distributed and rearranged alternately by the distributor 16. With the above-mentioned steps, the structure of the table generated by the generator 14 is confirmed. The structure of the generated table may be stored in a memory by the setter 11 as setting information. In this case, the structure of the generated table can be used when a next table is generated.

### 5. Table Generation Process

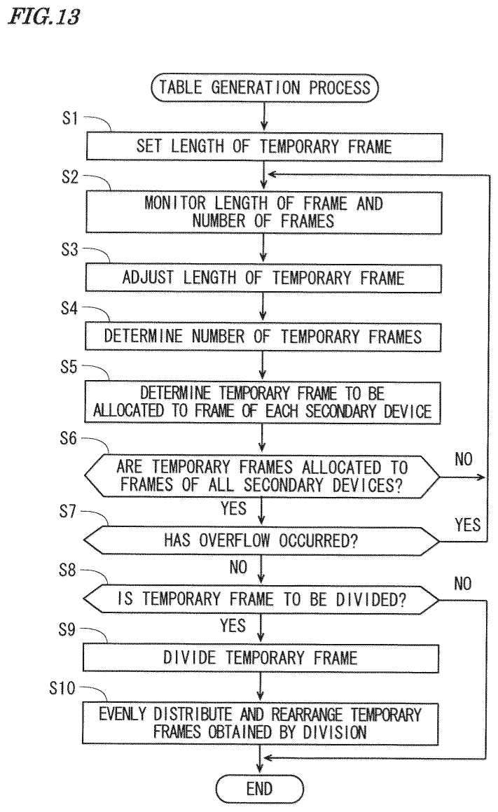

A table generation process is executed when the processor of the controller 110 executes a table generation program stored in a memory. The table generation process is a process for generating a table, and is started when the communication relay system 300 is activated, for example. The communication relay system 300 is activated when a mounted device (an FA device in the present example), for example, is activated. FIG. 13 is a flowchart showing one example of the table generation process. Hereinafter, the table generation process will be described with reference to FIG. 9.

First, the setter 11 sets the length of a temporary frame as an initial setting (step S1). Next, the monitor 12 monitors the length of a frame and the number of frames communicated between the primary device 100 and each secondary device 200 (step S2). Subsequently, the adjuster 13 adjusts the length of a temporary frame set in the step S1 based on the length of a frame and the number of frames monitored in the step S2 (step S3). Thereafter, the generator 14 determines the number of temporary frames of the table for each of the propagation paths 311, 312 (step S4).

Next, the generator 14 determines a temporary frame to be allocated to a frame of each secondary device 200 from among a plurality of temporary frames included in the table of each of the propagation paths 311, 312 (step S5). Here, a temporary frame located in the same period in the table of each of the propagation path 311 and the propagation path 312 is allocated to a secondary device 200 connected to an ultra-high definition camera or the like. Thus, the table is generated for each of the propagation paths 311, 312. Subsequently, the generator 14 determines whether temporary frames are allocated to the frames of all of the secondary devices 200 (step S6).

In a case in which temporary frames are allocated to the frames of all of the secondary devices 200, the generator 14 determines whether an overflow has occurred in any of the temporary frames (step S7). In a case in which the number of empty temporary frames in a temporary frame is smaller than a predetermined amount, it is determined that an overflow has occurred in the temporary frame. In a case in which an overflow flag for determining an occurrence of an overflow is inserted into a frame transmitted from each secondary device 200, it may be determined whether an overflow has occurred in a temporary frame based on the overflow flag.

In a case in which temporary frames are not allocated to the frames of all of the secondary device 200 in the step S6, or a case in which an overflow has occurred in any of the temporary frames in the step S7, the process returns to the step S2. Thus, temporary frames to be allocated to the frames of each secondary device 200 are adjusted. For example, in a case in which temporary frames are not allocated to the frames of all of the secondary devices 200, the number of temporary frames is reduced in regard to a secondary device 200 to which temporary frames are excessively allocated. Alternatively, in a case in which an overflow has occurred in any temporary frame, the number of temporary frames allocated to the frames of the corresponding secondary device 200 is preferentially increased.

The steps S2 to S7 are repeated until an overflow does not occur in any of the temporary frames. In a case in which an overflow does not occur in any of the temporary frames, the divider 15 determines whether any temporary frame is to be divided in the table generated in the step S5 (step S8). In a case in which any of the temporary frames is to be divided, the divider 15 divides the temporary frame (step S9). Thereafter, in the table, the distributor 16 evenly distributes and rearranges temporary frames obtained by division in the step S9 (step S10).

In a case in which none of the temporary frames is to be divided in the step S8, or a case in which the step S10 is executed, the table generated for each of the propagation paths 311, 312 is confirmed. Thus, the table generation process ends. In a case in which none of the temporary frames is to be divided in the step S8, the process may return to the step S2 before the table generation process ends. In this process, even after the steps S2 to S8 are repeated a predetermined number of times, in a case in which none of the temporary frames is to be divided in the step S8, the table generation process may end.

When the table generation process ends, the structure of a generated table may be saved as setting information. After the table generation process ends, the communication relay system 300 starts a normal work. In the normal work, frames are periodically and repeatedly communicated between the primary device 100 and each secondary device 200 through the propagation paths 311, 312 according to the generated table.

### 6. Transmitter and Receiver

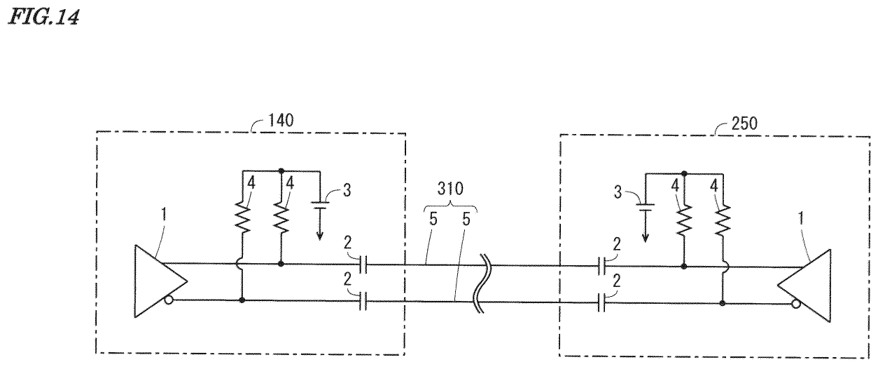

The configurations of the transmitters 140, 240 and the receivers 150, 250 will be described below. Here, the receiver 150 and the transmitter 240 respectively have the similar configurations to those of the receiver 250 and the transmitter 140. Therefore, a description of the receiver 150 and the transmitter 240 will not be provided. FIG. 14 is a diagram showing the configurations of the transmitter 140 and the receiver 250. In the present example, each of the plurality of propagation paths 310 has two wires 5 that transmit data using a differential method. FIG. 14 shows the configurations of a portion of the transmitter 140 and a portion of the receiver 250 corresponding to one propagation path 310.

As shown in FIG. 14, the transmitter 140 and the receiver 250 have the similar configurations. Specifically, each of the transmitter 140 and the receiver 250 includes an operational amplifier 1, a pair of capacitors 2, a DC power supply 3 and a pair of resistors 4. The operational amplifier 1 of the transmitter 140 and the operational amplifier 1 of the receiver 250 are connected to each other by a pair of wires 5. In each of the transmitter 140 and the receiver 250, the pair of capacitors 2 is provided in each of the pair of wires 5. A voltage for transmission or reception is applied to the pair of wires 5 by the DC power supply 3 through the pair of resistors 4.

With the above-mentioned configuration, data transmitted from the operational amplifier 1 of the transmitter 140 is received by the operational amplifier 1 of the receiver 250 through the pair of wires 5. Further, in each of the transmitter 140 and the receiver 250, because the capacitors 2 are provided in each of the wires 5, a DC component of a signal transmitted by each of the wires 5 is removed. Therefore, even in a case in which data is transmitted and received by the NRZ (Non Return to Zero) method, it is possible to prevent a problem caused by mismatch of bias levels of the operational amplifiers 1.

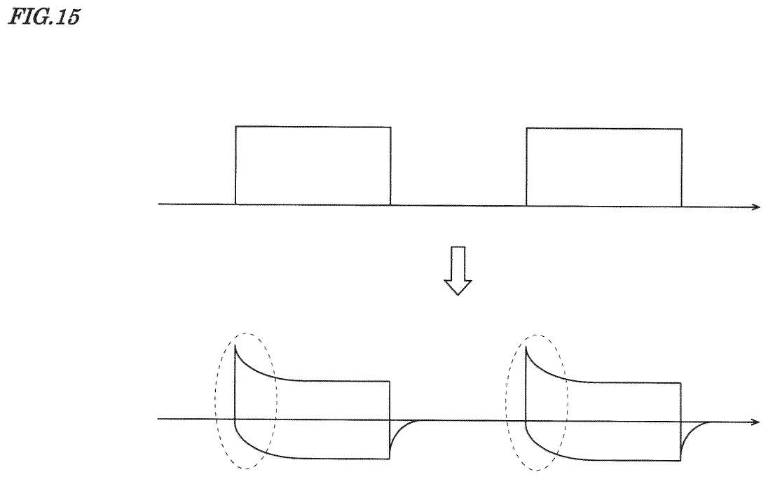

On the other hand, a waveform of data to be transmitted by each of the wires 5 may deform due to provision of the capacitors 2 in each of the wires 5. FIG. 15 is a diagram showing a waveform of data transmitted by each wire 5. As shown in the upper field of FIG. 15, the waveform of each frame included in the data to be transmitted is rectangular. When such frames are intermittently transmitted, as shown in the lower field of FIG. 15, a head portion of the waveform of the frame, with the head portion being a rising portion of the waveform circled by the dotted line, is greatly deformed due to a transient response of the capacitors 2. The deformed portion of the waveform of the frame may not be received due to an occurrence of an error.

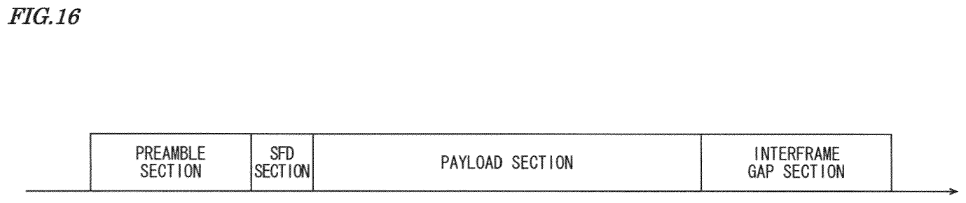

As such, in the present example, according to a user instruction, the transmitters 140, 240 can transmit frames in reverse order with the structure of each frame inverted. Here, each frame has a structure in which a plurality of layers are arranged. FIG. 16 is a diagram showing the structure of a frame. As shown in FIG. 16, in each frame, a preamble section, an SFD (Start Frame Delimiter) section, a payload section and an interframe gap section are arranged in this order from head to tail. The preamble section and the SFD section store information representing a start position of the frame and determining a period in which transmission and reception of frame are synchronized. The payload section stores the main body of information to be communicated. No information is stored in the interframe gap section.

In a case in which the structure of the frame in FIG. 16 is inverted, the interframe gap section is at the head of the frame, and the preamble section is at the tail end of the frame. Therefore, even when the head portion of the frame is not received due to deformation of the waveform of the frame, it improves the probability that the subsequent payload section, SFD section and preamble section are received without detection of an error. This enables stable transmission and reception of a frame even when a waveform of the frame is deformed.

### 7. Effects

In the communication relay system 300 according to the present embodiment, unique identifiers are assigned to the propagation paths 311, 312. Each secondary device 200 can communicate with the primary device 100. Thus, the communication between the main control device 400 connected to the primary device 100, and the electronic device 500 connected to each secondary device 200 is relayed.

Both of the primary device 100 and each secondary device 200 can selectively execute a first transmitting work and a second transmitting work. Here, the first transmitting work is the work for simultaneously transmitting data through both of the propagation paths 311, 312 in a single period. The second transmitting work is the work for transmitting data through one of the propagation paths 311, 312 in a single period.

In the primary device 100, frames forming data are stored in the transmission memories 121, 122 in a chronological order and in a complimentary manner. During the first transmitting work, frames stored in the transmission memories 121, 122 are output to the transmitters 141, 142 respectively corresponding to the propagation paths 311, 312 such that the order of identifiers assigned to the propagation paths 311, 312 corresponds to a chronological order of frames to be transmitted. During the second transmitting work, the frames stored in the transmission memories 121, 122 are output to any of the transmitters 141, 142. The frames output by the transmission memories 121, 122 are transmitted to any of the secondary devices 200 through the respectively corresponding propagation paths 311, 312 by the transmitters 141, 142.

In this case, during the first transmitting work, because two frames are simultaneously transmitted to any of the secondary devices 200 through the two propagation paths 311, 312, it is possible to efficiently transmit data having a large size. Further, since the chronological order of frames to be transmitted corresponds to the order of the identifiers assigned to the propagation paths 311, 312, even in a case in which the information representing the order of frames is not included in the data to be transmitted, the transmitted frames can be arranged in the chronological order.

Similarly, during the second transmitting work, because frames are transmitted to any of the secondary devices 200 in a chronological order through any of the propagation paths 311, 312, even in a case in which the information representing the order of frames is not included in data to be transmitted, the transmitted frames can be arranged in the chronological order. Therefore, it is not necessary to include the information representing the order of frames in the data to be transmitted, and it is not necessary to read and process the information representing the order of frames. Thus, in a case in which data is transmitted from the primary device 100 to each secondary device 200, it is possible to reduce latency.

In each secondary device 200, during the reception corresponding to the first transmitting work, it is possible to efficiently receive data having a large size using the receivers 251, 252. Further, as described above, since the chronological order of frames to be transmitted is known, even during the reception corresponding to any of the first transmitting work and the second transmitting work, it is easy to store, in a chronological order and in a complementary manner, frames received by the plurality of receivers 251, 252 in the reception memories 231, 232. Thus, it is possible to easily arrange the received frames in the chronological order.

Also during the first transmitting work of each secondary device, because two frames are simultaneously transmitted to the primary device 100 through the two propagation paths 311, 312, it is possible to efficiently transmit data having a large size. Further, since the chronological order of frames to be transmitted corresponds to the order of identifiers assigned to the propagation paths 311, 312, even in a case in which the information representing the order of frames is not included in the data to be transmitted, it is possible to arrange the transmitted frames in the chronological order.

Similarly, also during the second transmitting work of each secondary device 200, because frames are transmitted to the primary device 100 in a chronological order through any of the propagation paths 311, 312, even in a case in which the information representing the order of frames is not included in data to be transmitted, it is possible to arrange the transmitted frames in the chronological order. Therefore, it is not necessary to include the information representing the order of frames in the data to be transmitted, and it is not necessary to read and process the information representing the order of frames. Thus, also in a case in which data is transmitted from each secondary device 200 to the primary device 100, it is possible to reduce latency.

In the primary device 100, during the reception corresponding to the first transmitting work, it is possible to efficiently receive data having a large size using the receivers 151, 152. Further, as described above, since the chronological order of frames to be transmitted is known, also during the reception corresponding to any of the first transmitting work and the second transmitting work, it is easy to store, in a chronological order and in a complementary manner, frames received by the receivers 151, 152 in the reception memories 131, 132. Thus, it is possible to easily arrange the received frames in the chronological order.

Each of the transmitters 141, 142, 241, 242 can transmit each frame with the structure of each frame being inverted. With this configuration, even in a case in which the information for determining a period during which transmission and reception are synchronized is stored in the head of each frame, it is possible to transmit each frame such that the information is located at the tail end of each frame. Therefore, frames can be stably communicated between the primary device 100 and each secondary device 200.

The primary device 100 further includes the generator 14. In regard to each of the propagation paths 311, 312, the generator 14 generates, based on an amount of communication with each secondary device 200, a table in which a period used for communication with each secondary device 200 is allocated. Specifically, the generator 14 generates the table by determining Ne and n such that the above-mentioned formulas (1) and (2) are satisfied. Each of the transmission memories 121, 122, 221, 222 outputs a frame according to the table generated by the generator 14.

With this configuration, it is possible to easily determine a period to be allocated to communication of each secondary device. Further, even in a case in which a plurality of secondary devices 200 that execute communication with various communication amounts are provided, a period used for communication of each secondary device 200 is appropriately allocated for each of the propagation paths 311, 312 according to the communication amount of each secondary device 200. Therefore, it is possible to minimize a blank period that is not used for communication in the propagation paths 311, 312. This can improve the communication efficiency.

The generator 14 allocates a period used for communication with a specific secondary device 200 to the same periods in the two tables corresponding to the propagation paths 311, 312. In this case, it is possible to easily allocate the period during which the first transmitting work is performed to the table. Further, the specific secondary device 200 is a secondary device 200 that communicates data having a size larger than a predetermined size. In this case, it is possible to efficiently communicate data having a size larger than the predetermined size according to the generated table.

The primary device 100 further includes the divider 15 and the distributor 16. In a case in which, in a table generated by the generator 14, m periods each of which can be divided into m periods are present, and the m periods are allocated to communication with different secondary devices 200, the divider 15 divides each of the m periods into m periods. The distributor 16 evenly distributes and rearranges, in the table, periods into which the m periods are divided by the divider 15. In this case, in the table, a large number of periods that are shortened as much as possible are distributed and provided. Thus, it is possible to reduce latency in each period. Further, because the frequency of communication increases, the communication efficiency can be improved.

### 8. Other Embodiments

(1) While the primary device 100 and each secondary device 200 are configured to be capable of selectively performing a first transmitting work and a second transmitting work in the above-mentioned embodiment, the embodiment is not limited to this. As long as being configured to be capable of performing a first transmitting work, the primary device 100 or each secondary device 200 does not have to be configured to be capable of performing a second transmitting work.

(2) While the plurality of secondary devices 200 are provided in the communication relay system 300 in the above-mentioned embodiment, the embodiment is not limited to this. One secondary device 200 may be provided in the communication relay system 300.

(3) While the primary device 100 and each secondary device 200 are provided as part of the communication relay system 300 in the above-mentioned embodiment, the embodiment is not limited to this. The primary device 100 and each secondary device 200 may be provided separately from the communication relay system 300.

(4) In the above-mentioned embodiment, a preceding frame in a chronological order is transmitted through the propagation path 311 to which the number “1” is assigned, and a subsequent frame in the chronological order is transmitted through the propagation path 312 to which the number “2” is assigned. However, the embodiment is not limited to this. The order of numbers assigned to two or more propagation paths 310 used for transmission of frames is only required to correspond to the chronological order of frames to be transmitted. Therefore, a preceding frame in a chronological order may be transmitted through the propagation path 311 to which the number “2” is assigned, and a subsequent frame in the chronological order may be transmitted through the propagation path 312 to which the number “1” is assigned.

(5) While the number of propagation paths 310 is two in the above-mentioned embodiment, the embodiment is not limited to this. The number of propagation paths 310 may be K (K is an integer equal to or larger than three). In this case, in the primary device 100, K transmission memories 120, K reception memories 130, K transmitters 140 and K receivers 150 are provided. Further, in each secondary device 200, K transmission memories 220, K reception memories 230, K transmitters 240 and K receivers 250 are provided.

Specifically, in a period during which the propagation path 310 is not occupied by transmission, two or more transmission memories 120 out of the K transmission memories 120 output stored frames to any of the K transmitters 140 in a chronological order and alternately. The output destination of the frames is the transmitter 140 connected to the propagation path 310 used for transmission of frames. On the other hand, in a period during which two or more propagation paths 310 are occupied by transmission, two or more transmission memories 120 out of the K transmission memories 120 output stored frames to two or more transmitters 140 among the K transmitters 140 in a chronological order and simultaneously.

For example, in a case in which three propagation paths 310 are occupied by transmission, the output destination of the very first frame is the transmitter 140 corresponding to the propagation path 310 to which the number “1” is assigned, the output destination of the next frame is the transmitter 140 corresponding to the propagation path 310 to which the number “2” is assigned, and the output destination of the last frame is the transmitter 140 corresponding to the propagation path 310 to which the number “3” is assigned. In this case, the very first frame is transmitted through the propagation path 310 to which the number “1” is assigned, the next frame is transmitted through the propagation path 310 to which the number “2” is assigned, and the last frame is transmitted through the propagation path 310 to which the number “3” is assigned. The same applies to a case in which four or more propagation paths 310 are occupied by transmission.

Similarly, in a period during which either one of the propagation paths 310 is occupied by reception but not both, two or more reception memories 130 out of the K reception memories 130 output, in a chronological order and alternately, frames received by two or more receivers 150 out of the K receivers 150. On the other hand, in a period during which two or more propagation paths 310 are occupied by reception, two or more reception memories 130 out of the K reception memories 130 acquire and store, in a chronological order and simultaneously, frames received by two or more receivers 150 out of the K receivers 150.

For example, in a case in which three propagation paths 310 are occupied by reception, the reception memory 130 that is to store a frame first out of the three reception memories 130 stores a frame received by the receiver 150 connected to the propagation path 310 to which the number “1” is assigned. Further, the reception memory 130 that is to store a subsequent frame stores a frame received by the receiver 150 connected to the propagation path 310 to which the number “2” is assigned. Further, the reception memory 130 that is to store a frame last stores a frame received by the receiver 150 connected to the propagation path 310 to which the number “3” is assigned. The same applies to a case in which four or more propagation paths 310 are occupied by reception.

With this configuration, during a first transmitting work of the primary device 100 or each secondary device 200, data may be transmitted, in a single period, simultaneously through propagation paths 310 the number of which is not less than two and not more than (K−1). That is, in a case in which three or more propagation paths 310 are provided, it is not necessary to transmit data simultaneously through all of propagation paths during a first transmitting work. Therefore, the first transmitting work can be performed flexibly.

On the other hand, during a first transmitting work, data may be simultaneously transmitted, in a single period, through K, i.e., all of the propagation paths 310. In any case, frames are transmitted such that the order of identifiers assigned to two or more propagation paths 310 used for transmission of frames corresponds to the chronological order of frames to be transmitted. Therefore, even in a case in which data to be transmitted does not include information representing the order of frames, the transmitted frames can be arranged in a chronological order.

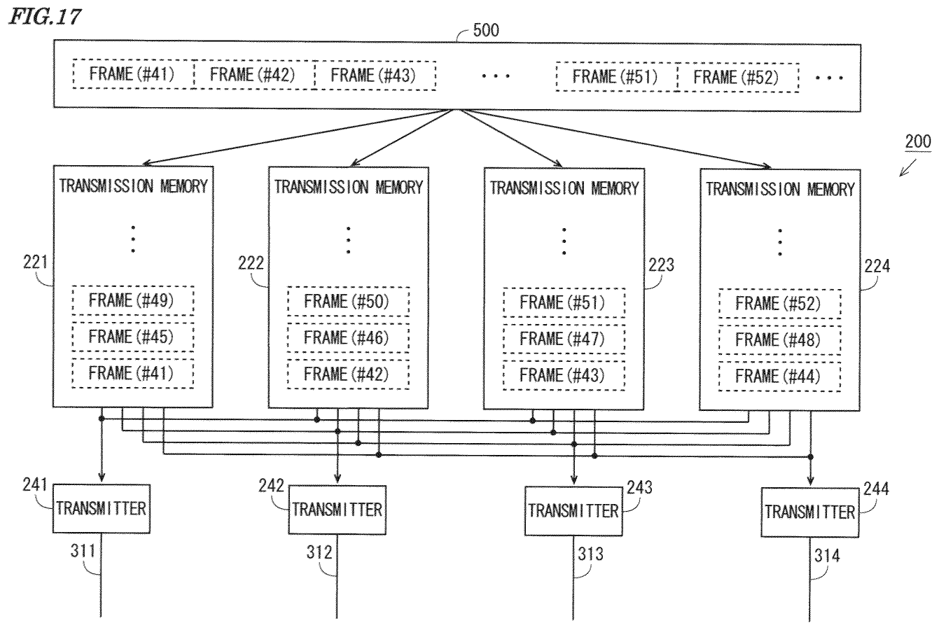

The work of the communication relay system 300 in a case in which K is 4 will be described below, by way of example. FIGS. 17 to 22 are schematic diagrams for explaining the work of the communication relay system 300 in a case in which K is four. In FIGS. 17 to 22, data is transmitted from a secondary device 200 to a primary device 100. An example for transmission of data from the primary device 100 to the secondary device 200 is similar to the example shown in FIGS. 17 to 22. Therefore, a description will not be provided.

As shown in FIGS. 17 to 22, in a case in which K is four, the communication relay system 300 includes four propagation paths 311 to 314 as a plurality of propagation paths 310. The number “1” is assigned to the propagation path 311, the number “2” is assigned to the propagation path 312, the number “3” is assigned to the propagation path 313, and the number “4” is assigned to the propagation path 314.

The primary device 100 includes transmission memories 121 to 124 as four transmission memories 120, reception memories 131 to 134 as four reception memories 130, transmitters 141 to 144 as four transmitters 140, and receivers 151 to 154 as four receivers 150. The transmission memories 121 to 124 are respectively connected to the transmitters 141 to 144. The reception memories 131 to 134 are respectively connected to the receivers 151 to 154. The transmitters 141 to 144 are respectively connected to the propagation paths 311 to 314. The receivers 151 to 154 are respectively connected to the propagation paths 311 to 314.

The secondary device 200 includes transmission memories 221 to 224 as four transmission memories 220, reception memories 231 to 234 as four reception memories 230, transmitters 241 to 244 as four transmitters 240, and receivers 251 to 254 as four receivers 250. The transmission memories 221 to 224 are respectively connected to the transmitters 241 to 244. The reception memories 231 to 234 are respectively connected to the receivers 251 to 254. The transmitters 241 to 244 are respectively connected to the propagation paths 311 to 314. The receivers 251 to 254 are respectively connected to the propagation paths 311 to 314.

Since respectively having the configurations similar to those of the transmission memories 221 to 224 and the transmitters 241 to 244 in the secondary device 200, the transmission memories 121 to 124 and the transmitters 141 to 144 in the primary device 100 are not shown in the diagram Since respectively having the configurations similar to those of the reception memories 131 to 134 and the receivers 151 to 154 in the primary device 100, the reception memories 231 to 234 and the receivers 251 to 254 in the secondary device 200 are not shown in the diagram.

As shown in FIG. 17, in the secondary device 200, the transmission memories 221 to 224 repeatedly store forty-first to fifty-second frames of data provided by an electronic device 500 in a predetermined chronological order. In the present example, the transmission memories 221, 222, 223, 224 store the frames in this order in a complementary manner.

Therefore, in the example of FIG. 17, the forty-first frame, the forty-fifth frame and the forty-ninth frame are stored in this order in the transmission memory 221. The forty-second frame, the forty-sixth frame and the fiftieth frame are stored in the transmission memory 222 in this order. The forty-third frame, the forty-seventh frame and the fifty-first frame are stored in the transmission memory 223 in this order. The forty-fourth frame, the forty-eighth frame and the fifty-second frame are stored in the transmission memory 224 in this order. Thereafter, the transmission memories 221 to 224 output the stored frames to the transmitters 241 to 244 in a period allocated to the propagation paths 311 to 314.

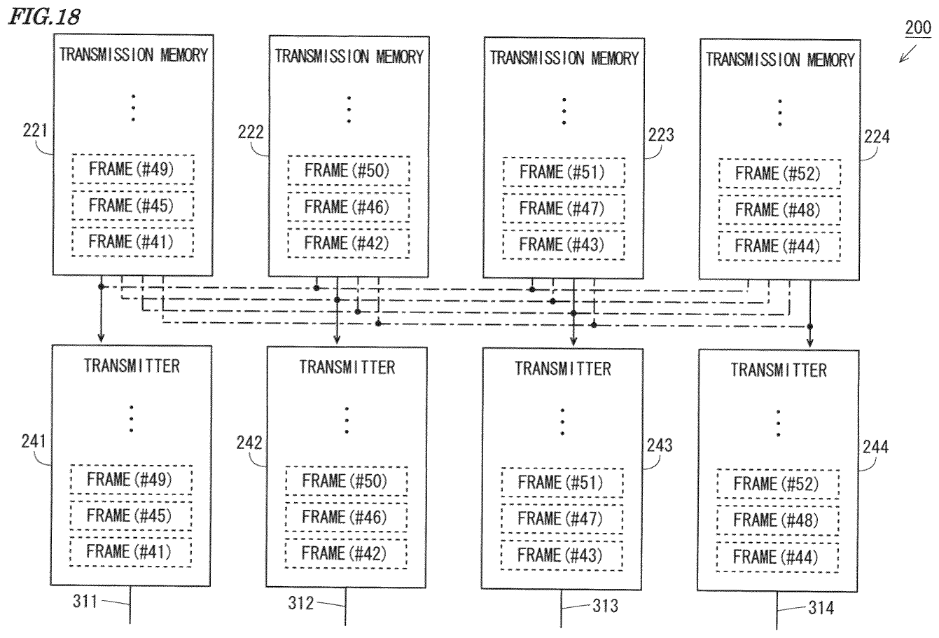

Here, in a certain period, all of the propagation paths 311 to 314 are occupied by transmission. In the example of FIG. 18, all of the propagation paths 311 to 314 are occupied by transmission in first to third periods. In this case, the transmission memories 221 to 224 repeatedly output the stored frames to the transmitters 241 to 244 in a chronological order and simultaneously.

In the present example, in the first period, the forty-first to forty-fourth frames are simultaneously output to the transmitters 241 to 244. In the second period, the forty-fifth to forty-eighth frames are simultaneously output to the transmitters 241 to 244. In the third period, the forty-ninth to fifty-second frames are simultaneously output to the transmitters 241 to 244.

Specifically, in the first period, the forty-first frame, which is the very first frame, is output from the transmission memory 221 to the transmitter 241 corresponding to the propagation path 311 to which the number “1” is assigned. The forty-second frame which is the next frame after the forty-first frame is output from the transmission memory 222 to the transmitter 242 corresponding to the propagation path 312 to which the number “2” is assigned. The forty-third frame, which is the next frame after the forty-second frame, is output from the transmission memory 223 to the transmitter 243 corresponding to the propagation path 313 to which the number “3” is assigned. The forty-fourth frame, which is the last frame, is output from the transmission memory 224 to the transmitter 244 corresponding to the propagation path 314 to which the number “4” is assigned.

Similarly, in the second period, the forty-fifth frame, which is the very first frame, is output from the transmission memory 221 to the transmitter 241. The forty-sixth frame, which is the next frame after the forty-fifth frame, is output from the transmission memory 222 to the transmitter 242. The forty-seventh frame, which is the next frame after the forty-sixth frame, is output from the transmission memory 223 to the transmitter 243. The forty-eighth frame, which is the last frame, is output from the transmission memory 224 to the transmitter 244.

In the third period, the forty-ninth frame, which is the very first frame, is output from the transmission memory 221 to the transmitter 241. The fiftieth frame, which is the next frame after the forty-ninth frame, is output from the transmission memory 222 to the transmitter 242. The fifty-first frame, which is the next frame after the fiftieth frame, is output from the transmission memory 223 to the transmitter 243. The fifty-second frame, which is the last frame, is output from the transmission memory 224 to the transmitter 244.

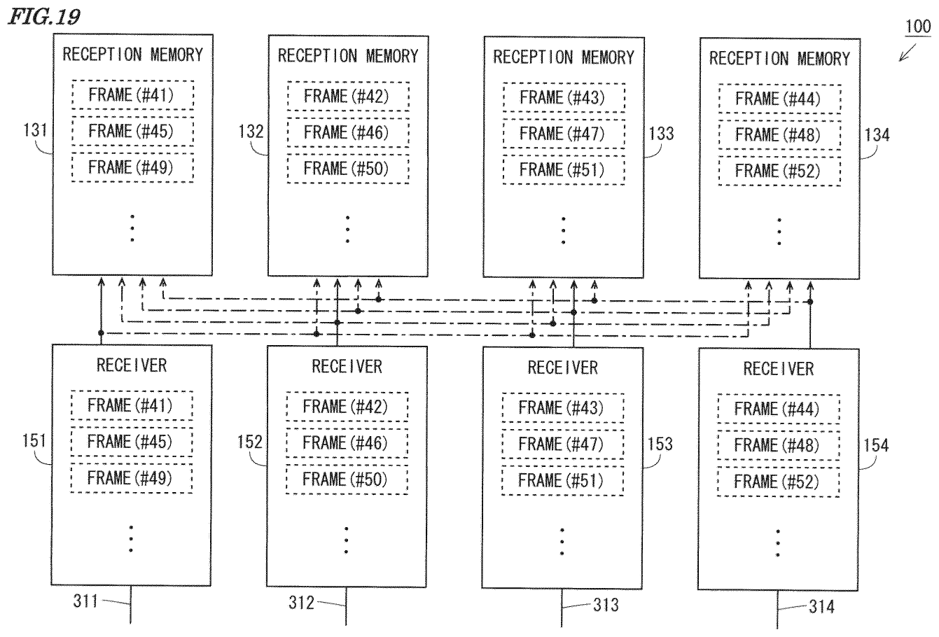

Note that, in order to facilitate understanding, in FIG. 18, between the transmission memories 221 to 224 and the transmitters 241 to 244, the wires used for output of frames are indicated by the solid lines, and the wires not used for outputting frames are indicated by the one dot and dash lines. The same applies to FIGS. 19 to 21.

The transmitters 241 to 244 respectively transmit the output frames to the primary device 100 through the propagation paths 311 to 314. When data is transmitted by the secondary device 200 to the primary device 100, data is received by the primary device 100. Specifically, frames transmitted through the propagation paths 311 to 314 are respectively received by the receivers 151 to 154.

In the example of FIG. 19, in a first period, the forty-first to forty-fourth frames are respectively and simultaneously received by the receivers 151 to 154. In a second period, the forty-fifth to forty-eighth frames are respectively and simultaneously received by the receivers 151 to 154. In a third period, the forty-ninth to fifty-second frames are respectively and simultaneously received by the receivers 151 to 154.

The reception memories 131 to 134 repeatedly acquire and store the frames received by the receivers 151 to 154 in a predetermined chronological order. In the present example, the reception memories 131, 132, 133, 134 store the frames in this order in a complementary manner. Further, suppose that the reception memory that is to store a subsequent frame is the reception memory 131. In this case, in the first period, the forty-first frame, which is the very first frame, is stored by the reception memory 131, the forty-second frame, which is the next frame after the forty-first frame, is stored by the reception memory 132, the forty-third frame, which is the next frame after the forty-second frame, is stored by the reception memory 133, and the forty-fourth frame, which is the last frame, is stored by the reception memory 134.

Thereafter, the reception memory that is to store a subsequent frame is also the reception memory 131. Therefore, in the second period, the forty-fifth frame, which is the very first frame, is stored by the reception memory 131, the forty-sixth frame, which is the next frame after the forty-fifth frame, is stored by the reception memory 132, the forty-seventh frame, which is the next frame after the forty-sixth frame, is stored by the reception memory 133, and the forty-eighth frame, which is the last frame, is stored by the reception memory 134.

Thereafter, the reception memory that is to store a subsequent frame is also the reception memory 131. Therefore, in the third period, the forty-ninth frame, which is the very first frame, is stored in the reception memory 131, the fiftieth frame, which is the next frame after the forty-ninth frame, is stored in the reception memory 132, the fifty-first frame, which is the next frame after the fiftieth frame, is stored in the reception memory 133, and the fifty-second frame, which is the last frame, is stored in the reception memory 134.

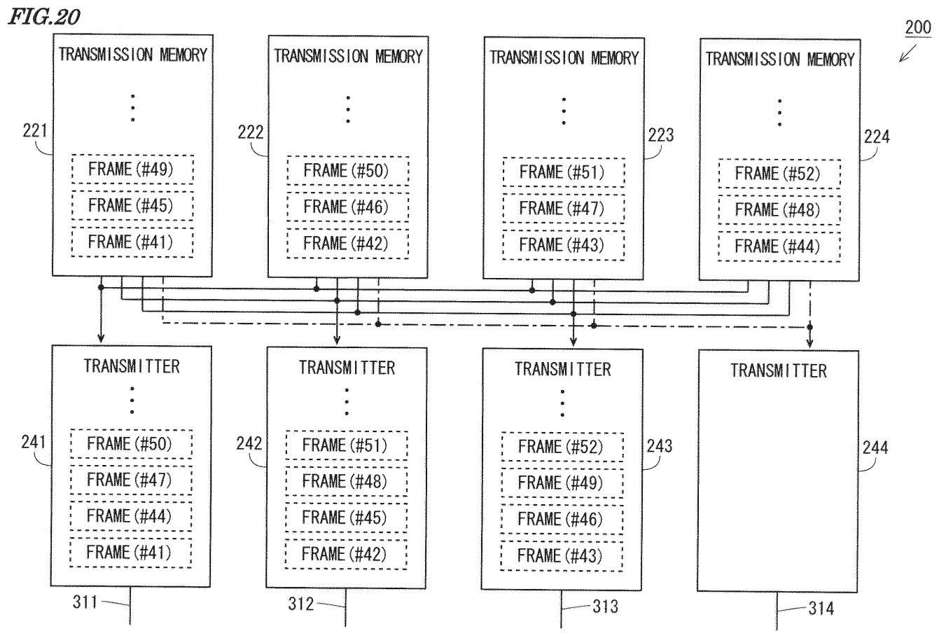

On the other hand, in a certain period, not all of the propagation paths 311 to 314 are occupied by transmission but two or more propagation paths 311 to 314 are occupied by transmission. In the example of FIG. 20, in first to fourth periods, three propagation paths 311 to 313 are occupied by transmission. In this case, the transmission memories 221 to 224 repeatedly output stored frames to the transmitters 241 to 243 (that is, the three transmitters 240 respectively connected to the propagation paths 311 to 313) in a chronological order and simultaneously.

In the present example, in the first period, the forty-first to forty-third frames are output to the transmitters 241 to 243 simultaneously. In the second period, the forty-fourth to forty-sixth frames are simultaneously output to the transmitters 241 to 243. In the third period, the forty-seventh to forty-ninth frames are simultaneously output to the transmitters 241 to 243. In the fourth period, the fiftieth to fifty-second frames are simultaneously output to the transmitters 241 to 243.

Specifically, in the first period, the forty-first frame, which is the very first frame, is output from the transmission memory 221 to the transmitter 241 corresponding to the propagation path 311 to which the number “1” is assigned. The forty-second frame, which is the next frame after the forty-first frame, is output from the transmission memory 222 to the transmitter 242 corresponding to the propagation path 312 to which the number “2” is assigned. The forty-third frame, which is the last frame, is output from the transmission memory 223 to the transmitter 243 corresponding to the propagation path 313 to which the number “3” is assigned.

Similarly, in the second period, the forty-fourth frame, which is the very first frame, is output from the transmission memory 224 to the transmitter 241. The forty-fifth frame, which is the next frame after the forty-fourth frame, is output from the transmission memory 221 to the transmitter 242. The forty-sixth frame, which is the last frame, is output from the transmission memory 222 to the transmitter 243.

In the third period, the forty-seventh frame, which is the very first frame, is output from the transmission memory 223 to the transmitter 241. The forty-eighth frame, which is the next frame to the forty-seventh frame, is output from the transmission memory 224 to the transmitter 242. The forty-ninth frame, which is the last frame, is output from the transmission memory 221 to the transmitter 243.

In the fourth period, the fiftieth frame, which is the very first frame, is output from the transmission memory 222 to the transmitter 241. The fifty-first frame, which is the next frame after the fiftieth frame, is output from the transmission memory 223 to the transmitter 242. The fifty-second frame, which is the last frame, is output from the transmission memory 224 to the transmitter 243.

The transmitters 241 to 243 respectively transmit the output frames to the primary device 100 through the propagation paths 311 to 313. When data is transmitted by the secondary device 200 to the primary device 100, the primary device 100 receives the data. Specifically, the frames transmitted through the propagation paths 311 to 313 are respectively received by the receivers 151 to 153.

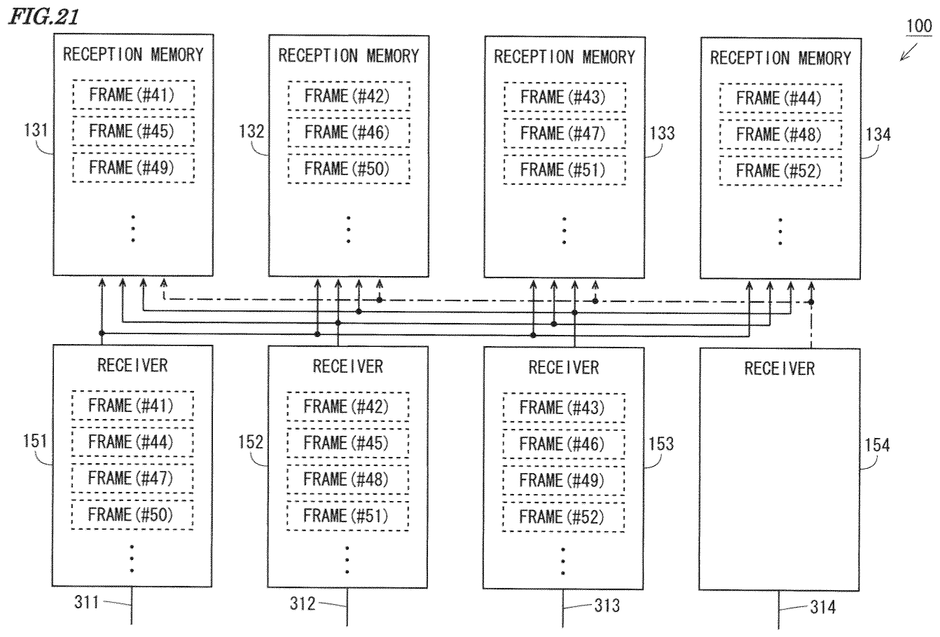

In the example of FIG. 21, in the first period, the forty-first to forty-third frames are respectively and simultaneously received by the receivers 151 to 153. In the second period, the forty-fourth to forty-sixth frames are respectively and simultaneously received by the receivers 151 to 153. In the third period, the forty-seventh to forty-ninth frames are respectively and simultaneously received by the receivers 151 to 153. In the fourth period, the fiftieth to fifty-second frames are respectively and simultaneously received by the receivers 151 to 153.

The reception memories 131 to 134 repeatedly acquire and store the frames received by the receivers 151 to 153 in a predetermined chronological order. In the present example, the reception memories 131, 132, 133, 134 store the frames in this order in a complementary manner. Further, suppose that the reception memory that is to store a subsequent frame is the reception memory 131. In this case, in the first period, the forty-first frame, which is the very first frame, is stored by the reception memory 131, the forty-second frame, which is the next frame after the forty-first frame, is stored by the reception memory 132, and the forty-third frame, which is the last frame, is stored by the reception memory 133.

Thereafter, the reception memory that is to store a subsequent frame is the reception memory 134. Therefore, in the second period, the forty-fourth frame, which is the very first frame, is stored by the reception memory 134, the forty-fifth frame, which is the next frame after the forty-fourth frame, is stored by the reception memory 131, and the forty-sixth frame, which is the last frame, is stored by the reception memory 132.

Thereafter, the reception memory that is to store a subsequent frame is the reception memory 133. Therefore, in the third period, the forty-seventh frame, which is the very first frame, is stored by the reception memory 133, the forty-eighth frame, which is the next frame after the forty-seventh frame, is stored by the reception memory 134, and the forty-ninth frame, which is the last frame, is stored by the reception memory 131.

Thereafter, the reception memory that is to store a subsequent frame is the reception memory 132. Therefore, in the fourth period, the fiftieth frame, which is the very first frame, is stored by the reception memory 132, the fifty-first frame, which is the next frame after the fiftieth frame, is stored by the reception memory 133, and the fifty-second frame, which is the last frame, is stored by the reception memory 134.

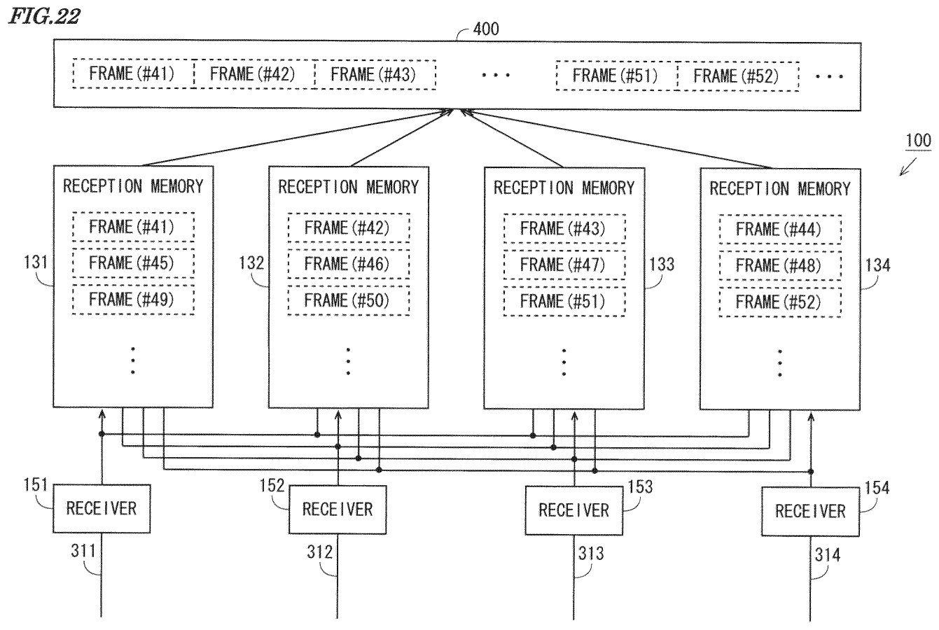

With the above-mentioned work of the communication relay system 300, as shown in FIG. 22, the forty-first frame, the forty-fifth frame and the forty-ninth frame are stored in the reception memory 131 in this order. The forty-second frame, the forty-sixth frame and the fiftieth frame are stored in the reception memory 132 in this order. The forty-third frame, the forty-seventh frame and the fifty-first frame are stored in the reception memory 133 in this order. The forty-fourth frame, the forty-eighth frame and the fifty-second frame are stored in the reception memory 134 in this order. Thereafter, the reception memories 131 to 134 output the stored frames to the main control device 400 in a chronological order and in a complementary manner.

(6) While the primary device 100 and each secondary device 200 communicate with each other through wired communication using a pair of physical wires 5 as each propagation path 310 in the above-mentioned embodiment, the embodiment is not limited to this. The primary device 100 and each secondary device 200 may communicate with each other through wireless communication. In this case, a plurality of propagation paths 310 are distinguished from one another based on frequency bands.

(7) In the above-mentioned embodiment, the primary device 100 includes the setter 11, the monitor 12, the adjuster 13, the generator 14, the divider 15 and the distributor 16 in the above-mentioned embodiment, the embodiment is not limited to this. In a case in which a temporal frame of a table is not to be divided, the primary device 100 does not have to include the divider 15 or the distributor 16. Further, in a case in which a table does not have to be generated, the primary device 100 does not have to include the generator 14 and does not have to include the setter 11, the monitor 12 or the adjuster 13.

(8) In the above-mentioned embodiment, the primary device 100 includes the plurality of transmission memories 120, and the plurality of transmission memories 120 are used as a plurality of transmission storages in the primary device 100. Further, each secondary device 200 includes the plurality of transmission memories 220, and the plurality of transmission memories 220 are used as a plurality of transmission storages in the secondary device 200.

However, the embodiment is not limited to the above-mentioned example.

The primary device 100 may include one transmission memory 120, and a plurality of storage areas provided in the one transmission memory 120 may be used as a plurality of transmission storages in the primary device 100. Further, each secondary device 200 may include one transmission memory 220, and a plurality of storage areas provided in the one transmission memory 220 may be used as a plurality of transmission storages in the secondary device 200.

(9) In the above-mentioned embodiment, the primary device 100 includes the plurality of reception memories 130, and the plurality of reception memories 130 are used as a plurality of transmission storages in the primary device 100. Further, each secondary device 200 includes the plurality of reception memories 230, and the plurality of reception memories 230 are used as a plurality of transmission storages in the secondary device 200.

However, the embodiment is not limited to the above-mentioned example. The primary device 100 may include one reception memory 130, and a plurality of storage areas provided in the one reception memory 130 may be used as a plurality of reception storages in the primary device 100. Further, each secondary device 200 may include one reception memory 230, and a plurality of storage areas provided in the one reception memory 230 may be used as a plurality of reception storages in the secondary device 200.

(10) The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### 9. Reference Example

In the above-mentioned embodiment, the primary device 100 and each secondary device 200 are configured to be capable of selectively performing a first transmitting work and a second transmitting work. However, the primary device 100 or each secondary device 200 may be configured to be capable of performing only a second transmitting work and does not have to be configured to be capable of performing a first transmitting work. Also in this case, a table may be generated to allocate a period used for communication between the primary device 100 and each secondary device 200 for each propagation path 310.

### 10. Correspondences Between Constituent Elements in Claims and Parts in Preferred Embodiments

In the following paragraphs, non-limiting examples of correspondences between various elements recited in the claims below and those described above with respect to various preferred embodiments of the present disclosure are explained. As each of various elements recited in the claims, various other elements having configurations or functions described in the claims can be also used.

In the above-mentioned embodiment, the propagation path 310 is an example of a propagation path, the primary device 100 is an example of a primary device, the secondary device 200 is an example of a secondary device, and the communication relay system 300 is an example of a communication relay system. The transmission memories 120, 220 are examples of a first transmission storage circuitry, a second transmission storage circuitry or a transmission storage circuitry, and the transmitters 140, 240 are examples of a first transmission circuitry, a second transmission circuitry or a transmission circuitry. The receivers 150, 250 are examples of a first reception circuitry or a second reception circuitry, the reception memories 130, 230 are examples of a first reception storage circuitry or a second reception storage circuitry, the generator 14 is an example of a generation circuitry, the divider 15 is an example of a division circuitry, and the distributor 16 is an example of a distribution circuitry.

### 11. Overview of Embodiments

(Item 1) A communication relay system according to item 1 includes a plurality of propagation paths to which unique identifiers are assigned, a primary device, and a secondary device capable of communicating with the primary device, wherein one device out of the primary device and the secondary device is capable of performing a first transmitting work of simultaneously transmitting data to another device through two or more propagation paths out of the plurality of propagation path in a single period, and includes a plurality of first transmission storage circuitries configured to store and output, in a chronological order and in a complementary manner, frames forming data, and a plurality of first transmission circuitries configured to be provided to respectively correspond to the plurality of propagation paths, and transmit frames to the another device through the plurality of corresponding propagation paths, with the frames being output by any of the plurality of first transmission storage circuitries, and the plurality of first transmission storage circuitries are configured to output frames to two or more first transmission circuitries respectively corresponding to two or more propagation paths during the first transmitting work such that an order of identifiers assigned to the two or more propagation paths used for transmission of frames corresponds to a chronological order of frames to be transmitted.

In this communication relay system, unique identifiers are assigned to the plurality of propagation paths. The secondary device can communicate with the primary device. Thus, the communication between devices respectively connected to the primary device and the secondary device is relayed. One of the primary device and the secondary device is capable of performing the first transmitting work of simultaneously transmitting data to the other device through two or more propagation paths out of the plurality of propagation paths in the single period.

In the one device, frames forming data are stored by the plurality of first transmission storage circuitries in a chronological order and in a complementary manner. During the first transmitting work, the frames stored by the plurality of first transmission storage circuitries are output to the two or more first transmission circuitries respectively corresponding to the two or more propagation paths, such that the order of identifiers assigned to the two or more propagation paths used for transmission of frames corresponds to a chronological order of frames to be transmitted. The frames output by the plurality of first transmission storage circuitries are transmitted to the other device through the plurality of respectively corresponding propagation paths by the plurality of first transmission circuitries.

In this case, during the first transmitting work, because two or more frames are simultaneously transmitted to the other device through the two or more propagation paths, it is possible to efficiently transmit data having a large size. Further, since the chronological order of frames to be transmitted corresponds to the order of identifiers assigned to the two or more propagation paths used for transmission of frames, even in a case in which the information representing the order of frames is not included in data to be transmitted, transmitted frames can be arranged in a chronological order.

Therefore, it is not necessary to include the information representing the order of frames in data to be transmitted, and it is not necessary to read and process the information representing the order of frames. Thus, in a case in which data is transmitted from the one device to the other device during the first transmitting work, latency can be reduced.

(Item 2) The communication relay system according to item 1, wherein the one device may be capable of selectively performing the first transmitting work and a second transmitting work, with the second transmitting work being a work of transmitting data to the another device through one propagation path out of the plurality of propagation paths in a single period, and the plurality of first transmission storage circuitries may be configured to output frames to any of the plurality of first transmission circuitries during the second transmitting work.

With this configuration, because frames are transmitted to the other device in a chronological order through any propagation path during the second transmitting work, even in a case in which the information representing the order of frames is not included in data to be transmitted, the transmitted frames can be arranged in the chronological order. Therefore, also during the second transmitting work, it is not necessary to include the information representing the order of frames in data to be transmitted, and it is not necessary to read and process the information representing the order of frames. Thus, in a case in which data is transmitted from the one device to the other device during the second transmitting work, latency can be reduced.

(Item 3) The communication relay system according to item 1 or 2, wherein the another device may include a plurality of first reception circuitries configured to be provided to respectively correspond to the plurality of propagation paths, and receive frames through the plurality of corresponding propagation paths, and a plurality of first reception storage circuitries configured to store, in a chronological order and in a complementary manner, frames received by the plurality of first reception circuitries.

In this case, during a first transmitting work, it is possible to efficiently receive data having a large size using the plurality of first reception circuitries. Further, as described above, since a chronological order of frames to be transmitted is known, it is easy to store, in a chronological order and in a complementary manner, during the first transmitting work, frames received by the plurality of first reception circuitries in the plurality of first reception storage circuitries. Thus, it is possible to easily arrange the received frames in the chronological order.

(Item 4) The communication relay system according to any one of items 1 to 3, wherein the plurality of first transmission circuitries may be configured to be capable of transmitting each frame with a structure of each frame inverted.

With this configuration, even in a case in which the information for determining a period during which transmission and reception are synchronized is stored in the head of each frame, it is possible to transmit each frame such that the information is located at the tail end of each frame. Therefore, even in a case in which a head portion, which is a rising portion of a waveform of each frame, is deformed due to a capacitive component provided in a propagation path, frames can be stably transmitted from the one device to the other device.

(Item 5) The communication relay system according to any one of items 1 to 4, wherein the another device may be capable of performing a third transmitting work of simultaneously transmitting data to the one device through two or more propagation paths out of the plurality of propagation paths in a single period, and may include a plurality of second transmission storage circuitries configured to store and output, in a chronological order and in a complementary manner, frames forming data, and a plurality of second transmission circuitries configured to be provided to respectively correspond to the plurality of propagation paths, and transmit frames to the one device through the plurality of corresponding propagation paths, with the frames being output by any of the plurality of second transmission storage circuitries, and the plurality of second transmission storage circuitries may be configured to output frames to two or more second transmission circuitries respectively corresponding to two or more propagation paths during the third transmitting work such that an order of identifiers assigned to the two or more propagation paths used for transmission of frames corresponds to a chronological order of frames to be transmitted.

In this case, because two or more frames are simultaneously transmitted to the one device through two or more propagation paths during a third transmitting work, it is possible to efficiently transmit data having a large size. Further, since a chronological order of frames to be transmitted corresponds to the order of identifiers assigned to the two or more propagation paths used for transmission of frames, even in a case in which the information representing the order of frames is not included in data to be transmitted, transmitted frames can be arranged in the chronological order.

Therefore, also during the third transmitting work, it is not necessary to include the information representing the order of frames in data to be transmitted, and it is not necessary to read and process the information representing the order of frames. Thus, even in a case in which data is transmitted from the other device to the one device during the third transmitting work, latency can be reduced.

(Item 6) The communication relay system according to item 5, wherein the another device may be capable of selectively performing the third transmitting work and a fourth transmitting work, with the fourth transmitting work being a work of transmitting data to the one device through one propagation path out of the plurality of propagation paths in a single period, and the plurality of second transmission storage circuitries may be configured to output frames to any of the plurality of second transmission circuitries during the fourth transmitting work.

With this configuration, because frames are transmitted to the one device in a chronological order through any propagation path during a fourth transmitting work, even in a case in which the information representing the order of frames is not included in data to be transmitted, transmitted frames can be arranged in the chronological order. Therefore, also during the fourth transmitting work, it is not necessary to include the information representing the order of frames in data to be transmitted, and it is not necessary to read and process the information representing the order of frames. Thus, in a case in which data is transmitted from the other device to the one device during the fourth transmitting work, latency can be reduced.

(Item 7) The communication relay system according to item 5 or 6, wherein the one device may include a plurality of second reception circuitries configured to be provided to respectively correspond to the plurality of propagation paths and receive frames through the plurality of corresponding propagation paths, and a plurality of second reception storage circuitries configured to store, in a chronological order and in a complementary manner, frames received by the plurality of second reception circuitries.

In this case, during a third transmitting work, it is possible to efficiently receive data having a large size using the plurality of second reception circuitries. Further, as described above, since a chronological order of frames to be transmitted is known, it is easy to store frames received by the plurality of second reception circuitries in the plurality of second reception storage circuitries in the chronological order and in a complementary manner during the third transmitting work. Thus, it is possible to easily arrange the received frames in the chronological order.

(Item 8) The communication relay system according to any one of items 5 to 7, wherein the plurality of second transmission circuitries may be configured to be capable of transmitting each frame with a structure of each frame inverted.

With this configuration, even in a case in which the information for determining a period during which transmission and reception are synchronized is stored in the head of each frame, it is possible to transmit each frame such that the information is located at the tail end of each frame. Therefore, even in a case in which a head portion, which is a rising portion of a waveform of each frame, is deformed due to a capacitive component provided in a propagation path, frames can be stably transmitted from the other device to the one device.

(Item 9) The communication relay system according to any one of items 1 to 8, wherein a plurality of the secondary devices may be provided, the primary device may further include a generation circuitry configured to generate, based on an amount of communication with each secondary device, in regard to each of a plurality of propagation paths, a table in which a period used for transmission with each secondary device is allocated, and the plurality of first transmission storage circuitries may be configured to output frames according to the table generated by the generation circuitry.

With this configuration, even in a case in which a plurality of secondary devices that execute communication with various communication amounts are provided, a period used for communication of each secondary device is appropriately allocated to each propagation path according to a communication amount of each secondary device. Therefore, it is possible to minimize a blank period not used for communication in the propagation path. This can improve the communication efficiency.

(Item 10) The communication relay system according to item 9, wherein in a case in which, in regard to frames to be communicated between the primary device and each secondary device, a length of a largest frame is Nmax, a length of a frame having a largest communication amount is N, a count of frames having the largest communication amount is n, a length of a frame of a table is Ne, and a margin of a frame of the table is α, the generation circuitry may be configured to generate the table by determining Ne and n such that following formulas (1) and (2) hold.

In this case, it is possible to easily determine a period to be allocated to communication of each secondary device.

(Item 11) The communication relay system according to item 9 or 10, wherein the generation circuitry may be configured to allocate a period used for communication with a specific secondary device to same periods in two or more tables corresponding to two or more propagation paths out of the plurality of propagation paths.

In this case, it is possible to easily allocate the period during which the first transmitting work is performed to the table.

(Item 12) The communication relay system according to item 11, wherein the specific secondary device may communicate data having a size larger than a predetermined size.

In this case, it is possible to efficiently communicate data having a size larger than the predetermined size according to a generated table.

(Item 13) The communication relay system according to any one of items 9 to 12, wherein the primary device may further include a division circuitry configured to, in a case in which m (m is equal to or larger than two) original periods, each of which is dividable into m sub-periods, are present and the m original periods are allocated to communication with different secondary devices in a table generated by the generation circuitry, divide each of the m original periods into m sub-periods, and a distribution circuitry configured to evenly distribute and rearrange, in a table, the sub-periods resulting from the division by the division circuitry.

In this case, in the table, a large number of periods that are shortened as much as possible are distributed and provided. Thus, it is possible to reduce latency in each period. Further, because the frequency of communication increases, the communication efficiency can be improved.

(Item 14) The communication relay system according to any one of items 1 to 13, wherein K (K is equal to or larger than three) propagation paths may be provided, and the first transmitting work may be a work of simultaneously transmitting data through propagation paths a count of which is not less than two and not more than (K−1) out of K propagation paths in a single period.

With this configuration, in a case in which three or more propagation paths are provided, it is not necessary to simultaneously transmit data through all of propagation paths during the first transmitting work. Therefore, the first transmitting work can be performed flexibly.

(Item 15) A primary device according to item 15 is provided in a communication relay system, with the communication relay system including a plurality of propagation paths to which unique identifiers are assigned and a secondary device, wherein the primary device is capable of communicating with the secondary device, is capable of performing a first transmitting work of simultaneously transmitting data to the secondary device through two or more propagation paths out of the plurality of propagation paths in a single period, and includes a plurality of transmission storage circuitries configured to store and output, in a chronological order and in a complementary manner, frames forming data, and a plurality of transmission circuitries configured to be provided to respectively correspond to the plurality of propagation paths, and transmit frames output by any of the plurality of transmission storage circuitries to the secondary device through the plurality of corresponding propagation paths, and the plurality of transmission storage circuitries are configured to output frames to two or more transmission circuitries respectively corresponding to two or more propagation paths during the first transmitting work such that an order of identifiers assigned to the two or more propagation paths used for transmission of frames corresponds to a chronological order of frames to be transmitted.

In this primary device, because two or more frames are simultaneously transmitted to the secondary device through the two or more propagation paths during the first transmitting work, it is possible to efficiently transmit data having a large size. Further, since a chronological order of frames to be transmitted corresponds to the order of identifiers assigned to the two or more propagation paths used for transmission of frames, even in a case in which the information representing the order of frames is not included in data to be transmitted, transmitted frames can be arranged in the chronological order.

Therefore, it is not necessary to include the information representing the order of frames in data to be transmitted, and it is not necessary to read and process the information representing the order of frames. Thus, in a case in which data is transmitted from the primary device to the secondary device during the first transmitting work, latency can be reduced.

(Item 16) A secondary device according to item 16 is provided in a communication system, with the communication system including a plurality of propagation paths to which unique identifiers are assigned and a primary device, wherein the secondary device is capable of communicating with the primary device, is capable of performing a first transmitting work of simultaneously transmitting data to the primary device through two or more propagation paths out of the plurality of propagation paths in a single period, and includes a plurality of transmission storage circuitries configured to store and output, in a chronological order and in a complementary manner, frames forming data, and a plurality of transmission circuitries configured to be provided to respectively correspond to the plurality of propagation paths, and transmit frames output by any of the plurality of transmission storage circuitries to the primary device through the plurality of corresponding propagation paths, and the plurality of transmission storage circuitries are configured to output frames to two or more transmission circuitries respectively corresponding to two or more propagation paths such that an order of identifiers assigned to the two or more propagation paths used for transmission of frames corresponds to a chronological order of frames to be transmitted.

In this secondary device, because two or more frames are simultaneously transmitted to the primary device through the two or more propagation paths during the first transmitting work, it is possible to efficiently transmit data having a large size. Further, since a chronological order of frames to be transmitted corresponds to the order of identifiers assigned to the two or more propagation paths used for transmission of frames, even in a case in which the information representing the order of frames is not included in data to be transmitted, transmitted frames can be arranged in the chronological order.

Therefore, it is not necessary to include the information representing the order of frames in data to be transmitted, and it is not necessary to read and process the information representing the order of frames. Thus, in a case in which data is transmitted from the secondary device to the primary device during the first transmitting work, latency can be reduced.

(Item 17) A communication relay method according to item 17 with which a plurality of propagation paths to which unique identifiers are assigned, a primary device and a secondary device are used, wherein the secondary device is capable of communicating with the primary device, one device out of the primary device and the secondary device is capable of performing a first transmitting work of simultaneously transmitting data to another device through two or more propagation paths out of the plurality of propagation paths in a single period using a plurality of transmission storage circuitries and a plurality of transmission circuitries, with the plurality of transmission circuitries being provided to respectively correspond to the plurality of propagation paths, and the communication relay method includes storing frames in a chronological order and in a complementary manner using the plurality of transmission storage circuitries, with the frames forming data, outputting, during the first transmitting work, frames stored by the plurality of transmission storage circuitries to two or more transmission circuitries respectively corresponding to two or more propagation paths such that an order of identifiers assigned to the two or more propagation paths used for transmission of frames corresponds to a chronological order of frames to be transmitted, and transmitting frames output by the plurality of transmission storage circuitries to the another device through the plurality of respectively corresponding propagation paths using the plurality of transmission circuitries.

With this communication relay method, because two or more frames are simultaneously transmitted to the other device through the two or more propagation paths during the first transmitting work, it is possible to efficiently transmit data having a large size. Further, since a chronological order of frames to be transmitted corresponds to the order of identifiers assigned to the two or more propagation paths used for transmission of frames, even in a case in which the information representing the order of frames is not included in data to be transmitted, transmitted frames can be arranged in the chronological order.

Therefore, it is not necessary to include the information representing the order of frames in data to be transmitted, and it is not necessary to read and process the information representing the order of frames. Thus, in a case in which data is transmitted from the one device to the other device during the first transmitting work, latency can be reduced.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A communication relay system comprising:
a plurality of propagation paths to which unique identifiers are assigned;
a primary device; and
a secondary device capable of communicating with the primary device, wherein
one device out of the primary device and the secondary device
is capable of performing a first transmitting work of simultaneously transmitting data to another device through two or more propagation paths out of the plurality of propagation path in a single period, and
includes
a plurality of first transmission storage circuitries configured to store and output, in a chronological order and in a complementary manner, frames forming data, and
a plurality of first transmission circuitries configured to be provided to respectively correspond to the plurality of propagation paths, and transmit frames to the another device through the plurality of corresponding propagation paths, with the frames being output by any of the plurality of first transmission storage circuitries, and
the plurality of first transmission storage circuitries are configured to output frames to two or more first transmission circuitries respectively corresponding to two or more propagation paths during the first transmitting work such that an order of identifiers assigned to the two or more propagation paths used for transmission of frames corresponds to a chronological order of frames to be transmitted.

2. The communication relay system according to claim 1, wherein
the one device is capable of selectively performing the first transmitting work and a second transmitting work, with the second transmitting work being a work of transmitting data to the another device through one propagation path out of the plurality of propagation paths in a single period, and
the plurality of first transmission storage circuitries are configured to output frames to any of the plurality of first transmission circuitries during the second transmitting work.

3. The communication relay system according to claim 1, wherein
the another device includes
a plurality of first reception circuitries configured to be provided to respectively correspond to the plurality of propagation paths, and receive frames through the plurality of corresponding propagation paths, and
a plurality of first reception storage circuitries configured to store, in a chronological order and in a complementary manner, frames received by the plurality of first reception circuitries.

4. The communication relay system according to claim 1, wherein
the plurality of first transmission circuitries are configured to be capable of transmitting each frame with a structure of each frame inverted.

5. The communication relay system according to claim 1, wherein
the another device
is capable of performing a third transmitting work of simultaneously transmitting data to the one device through two or more propagation paths out of the plurality of propagation paths in a single period, and
includes
a plurality of second transmission storage circuitries configured to store and output, in a chronological order and in a complementary manner, frames forming data, and
a plurality of second transmission circuitries configured to be provided to respectively correspond to the plurality of propagation paths, and transmit frames to the one device through the plurality of corresponding propagation paths, with the frames being output by any of the plurality of second transmission storage circuitries, and
the plurality of second transmission storage circuitries are configured to output frames to two or more second transmission circuitries respectively corresponding to two or more propagation paths during the third transmitting work such that an order of identifiers assigned to the two or more propagation paths used for transmission of frames corresponds to a chronological order of frames to be transmitted.

6. The communication relay system according to claim 5, wherein
the another device is capable of selectively performing the third transmitting work and a fourth transmitting work, with the fourth transmitting work being a work of transmitting data to the one device through one propagation path out of the plurality of propagation paths in a single period, and
the plurality of second transmission storage circuitries are configured to output frames to any of the plurality of second transmission circuitries during the fourth transmitting work.

7. The communication relay system according to claim 5, wherein
the one device includes
a plurality of second reception circuitries configured to be provided to respectively correspond to the plurality of propagation paths and receive frames through the plurality of corresponding propagation paths, and
a plurality of second reception storage circuitries configured to store, in a chronological order and in a complementary manner, frames received by the plurality of second reception circuitries.

8. The communication relay system according to claim 5, wherein
the plurality of second transmission circuitries are configured to be capable of transmitting each frame with a structure of each frame inverted.

9. The communication relay system according to claim 1, wherein
a plurality of the secondary devices are provided,
the primary device further includes a generation circuitry configured to generate, based on an amount of communication with each secondary device, in regard to each of a plurality of propagation paths, a table in which a period used for transmission with each secondary device is allocated, and
the plurality of first transmission storage circuitries are configured to output frames according to the table generated by the generation circuitry.

10. The communication relay system according to claim 9, wherein
in a case in which, in regard to frames to be communicated between the primary device and each secondary device, a length of a largest frame is Nmax, a length of a frame having a largest communication amount is N, a count of frames having the largest communication amount is n, a length of a frame of a table is Ne, and a margin of a frame of the table is α, the generation circuitry is configured to generate the table by determining Ne and n such that following formulas (1) and (2) hold.
$$Nmax \leq Ne \qquad ( 1 )$$
$$n \times N < Ne < n \times N + α \qquad ( 2 )$$

11. The communication relay system according to claim 9, wherein
the generation circuitry is configured to allocate a period used for communication with a specific secondary device to same periods in two or more tables corresponding to two or more propagation paths out of the plurality of propagation paths.

12. The communication relay system according to claim 11, wherein
the specific secondary device communicates data having a size larger than a predetermined size.

13. The communication relay system according to claim 9, wherein
the primary device further includes
a division circuitry configured to, in a case in which m (m is equal to or larger than two) original periods, each of which is dividable into m sub-periods, are present and the m original periods are allocated to communication with different secondary devices in a table generated by the generation circuitry, divide each of the m original periods into m sub-periods, and
a distribution circuitry configured to evenly distribute and rearrange, in a table, the sub-periods resulting from the division by the division circuitry.

14. The communication relay system according to claim 1, wherein
K (K is equal to or larger than three) propagation paths are provided, and
the first transmitting work is a work of simultaneously transmitting data through propagation paths a count of which is not less than two and not more than (K−1) out of K propagation paths in a single period.

15. A communication device provided in a communication relay system, the communication relay system including a plurality of propagation paths to which unique identifiers are assigned and another communication device with which the communication device is capable of communicating, wherein
the communication device
is capable of performing a first transmitting work of simultaneously transmitting data to the another communication device through two or more propagation paths out of the plurality of propagation paths in a single period, and
includes
a plurality of transmission storage circuitries configured to store and output, in a chronological order and in a complementary manner, frames forming data, and
a plurality of transmission circuitries configured to be provided to respectively correspond to the plurality of propagation paths, and transmit frames output by any of the plurality of transmission storage circuitries to the another communication device through the plurality of corresponding propagation paths, and
the plurality of transmission storage circuitries are configured to output frames to two or more transmission circuitries respectively corresponding to two or more propagation paths during the first transmitting work such that an order of identifiers assigned to the two or more propagation paths used for transmission of frames corresponds to a chronological order of frames to be transmitted.

16. A communication relay method with which a plurality of propagation paths to which unique identifiers are assigned, a primary device and a secondary device are used, wherein
the secondary device is capable of communicating with the primary device,
one device out of the primary device and the secondary device is capable of performing a first transmitting work of simultaneously transmitting data to another device through two or more propagation paths out of the plurality of propagation paths in a single period using a plurality of transmission storage circuitries and a plurality of transmission circuitries, with the plurality of transmission circuitries being provided to respectively correspond to the plurality of propagation paths, and
the communication relay method includes
storing frames in a chronological order and in a complementary manner using the plurality of transmission storage circuitries, with the frames forming data,
outputting, during the first transmitting work, frames stored by the plurality of transmission storage circuitries to two or more transmission circuitries respectively corresponding to two or more propagation paths such that an order of identifiers assigned to the two or more propagation paths used for transmission of frames corresponds to a chronological order of frames to be transmitted, and
transmitting frames output by the plurality of transmission storage circuitries to the another device through the plurality of respectively corresponding propagation paths using the plurality of transmission circuitries.
